(19) United States
(12) Patent Application Publication
(10) Pub. No.: US 2009/0299852 A1
(43) Pub. Date: Dec. 3, 2009

(54) CONTENTS DISTRIBUTING SYSTEM, DEVICE FOR PROCESSING CHARGE FOR ADVERTISEMENT INFORMATION, CONTENTS DISTRIBUTING SERVER, THEIR PROGRAM, AND PROGRAM RECORDING MEDIUM

(75) Inventor: Atsushi Tsuchiya, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SONY CORPORATION, Tokyo (JP)

(21) Appl. No.: 12/508,980

(22) Filed: Jul. 24, 2009

Related U.S. Application Data
(62) Division of application No. 10/287,835, filed on Nov. 5, 2002.

(30) Foreign Application Priority Data
Nov. 9, 2001 (JP) P2001-344548
Feb. 14, 2002 (JP) P2002-037062

(51) Int. Cl. G06Q 30/00; G06F 17/40; G06F 15/16

(52) U.S. Cl. 705/14.45; 705/14.54; 705/14.69; 709/203

(57) ABSTRACT

A content distributing system distributes advertisement information concurrent with distribution of content. A content distributing server, connected to a communication network, supplies content and advertisement information to a member device in response to a request, transmits introducing information to the member devices, receives information on whether a user has performed an action in response thereto, receives information provided by the user in accordance with the introducing information, records the received user action information and user-provided information, calculates an advertisement charge based on the recorded information, and outputs the calculated advertisement charge.

### CROSS-REFERENCE TO RELATED APPLICATIONS

This application is a divisional of U.S. application Ser. No. 10/287,835, filed on Nov. 5, 2002, which claims priority from Japanese Applications Nos. 2001-344548 filed Nov. 9, 2001 and 2002-037062 filed Feb. 14, 2002, the disclosures of which are incorporated herein by reference.

### BACKGROUND OF THE INVENTION

The present invention relates to a contents distributing system, a device for processing a charge of advertisement information, a contents distributing server, their programs, and a program recording medium.

Conventionally, a provider of products and services gives a demander or buyer an impact of the products by publishing an advertisement on a medium (advertisement medium) for promoting sales, and promotes an inclination to buy the product or service.

Conventional advertisement media use printing media such as newspapers and magazines and broadcast media such as radio and TV. Further, the advertisement media use, as an effective advertisement method, Internet advertisements, typically, banner advertisements, due to the spread and development of the Internet based on the recent communication technology and information processing technology.

Furthermore, the improvement of processing speed of processors and the spread of an optical fiber communication network cause the spread of streaming. Thus, similarly to TV, a client downloads and reads moving picture data and audio data on the Internet, and an Internet TV and an Internet radio appear. As new advertisement media, the Internet TV and the Internet radio provide advertisement information containing a moving picture and an audio file in combination with contents supplied to a user.

In recent years, the sales of products and the like via the Internet have gradually increased. Advertisement information is sent to users by both a product manufacturer and a seller by various media such as a sales site, an e-mail, and a e-mail magazine to improve sales. However, the users select the products further deliberately because of changes such as user's trends of individuation and genuine articles.

Since the conventional advertisement media contain one-way information from a transmission side to a viewer, they cannot handle information from the viewer to an advertisement provider. The property of advertisement viewers is grasped only by sending out questionnaires to the viewers and collecting information such as the property of the advertisement viewers. The information collection using questionnaires has problems such as the lack of accuracy, the increase in costs, and the like.

U.S. Pat. Publication No. 5,948,061 discloses a technology using conventional radio media for grasping the viewer's property of an Internet advertisement such as a banner advertisement on the Internet. However, this technology is not more advantageous than broadcasting advertisements using moving pictures or sound as an advertisement method.

Advertisements using the Internet TV or the Internet radio are distributed to many viewers other than a target audience of an advertiser because a common advertisement is distributed to many arbitrary viewers. Further, the distribution of the advertisement to viewers other than the target audience of the advertiser causes an advertisement charge.

The advertisement information on the product from a conventional supply side of the products cannot drive users to buy.

Currently, many users know that the most accurate information source to obtain an appropriate estimation and impression of the products is information provided by the users who actually purchase the products, i.e., word-of-mouth information. The users desire that they purchase the products without fail by collecting information of users who use the products and that the possibility of failure is suppressed.

However, the estimation information of the products provided by the users is not necessarily spread to the market. If the estimation information is valid, only a limited part of the users can use the estimation information. Because the user as the information source receives no value for providing the appropriate estimation information, although the users have various comments, they do not disclose the information and waste the information.

### BRIEF SUMMARY OF THE INVENTION

Accordingly, one such embodiment of the present invention provides an Internet advertisement system in which when an advertisement is distributed to viewers other than a target audience of an advertiser, the occurrence of an advertisement charge is prevented and the advertisement cost of the advertiser can efficiently be used.

A further such embodiment of the present invention provides an Internet advertisement system in which information is collected by promoting predetermined actions of an advertisement viewer (request of a catalog, questionnaire, participation in a prize (quiz)) during viewing the advertisement and the collection of marketing information of the advertiser is supported by feed-back of the collected information to the advertiser.

A still further such embodiment of the present invention provides an Internet advertisement system in which the active viewing of the advertisement is promoted by giving an incentive to a viewer and the viewer's action (request for a catalog, questionnaire, participation in a prize (quiz)) is encouraged during viewing the advertisement.

An additional such embodiment of the present invention promotes active presentation of a user's individual estimation information by providing an incentive for a user's valid estimation information on products, etc. and to increase a consumer's interest in the product purchase by enabling another user to use the estimation information.

A still additional such embodiment of the present invention improves the quality of the user's estimation information by appraising the estimation information of one user by another user.

To solve the above-mentioned problems, the present invention has the following features.

That is, according to a first aspect of the present invention, a contents distributing system for distributing advertisement information simultaneously with the distribution of contents includes a communication network; a contents distributing server connected to the communication network; an advertisement charge processing device connected to the contents distributing server; and a member device connected to the communication network.

The contents distributing server is operable to supply contents and advertisement information to the member device in response to a request from the member device, and to supply a transmission log to the advertisement charge processing device indicating which advertisement information has been transmitted to the member device.

The member device is operable to request the contents from the contents distributing server and to receive the contents supplied from the contents distributing server in response to the request. The user of the member device reads and enjoys the contents. In this case, the advertisement information distributed together with the contents is read and it promotes the user to browse the advertisement.

The advertisement charge processing device is operable to record the transmission log supplied from the contents distributing server, to calculate an advertisement charge based on the transmission log, and to output the calculated advertisement charge if necessary. Thus, a system can be structured in which the advertiser pays the advertisement charge only when the users as a marketing target view the advertisement information, and the advertisement cost can effectively be used.

According to a second aspect of the present invention, a contents distributing server for distributing advertisement information simultaneously with the distribution of contents includes a contents transmitting unit operable to transmit contents and advertisement information in response to a request; a user action introducing unit operable to receive a notification of the transmitted advertisement information from the contents transmitting unit, to transmit introduction information in accordance with the advertisement information to a member device which receives the advertisement information, to receive information on a user action in response to the introduction information from the member device, and to record the information on the user action; and a charge calculating unit operable to calculate an amount of money charged to an advertiser by referring to the information on the user action recorded to the user action introducing unit.

The contents distributing server provides information for promoting a user action, e.g., news of receiving the request of a catalog, questionnaire, and participation in a prize, obtains information on a user who reacts to the promotion information (containing the property information), and provides the obtained information to the advertiser. The advertiser can know the user who is interested in the product relating to the advertisement information and can obtain a hint of new promotion activities.

Preferably, the contents distributing server according to the second aspect of the present invention further includes an incentive processing unit including an incentive giving condition recording unit operable to record a condition for giving a user an incentive, and an incentive calculating unit operable to calculate an amount of the incentive given to the user based on at least one of the information on the user and a transmission log.

The promotion of the user action needs to overcome problems on work and time which are required by the user action. However, generally, the above-mentioned introduction of the user action is not easy. Therefore, the user action is promoted by giving the incentive which facilitates the introduction thereof.

According to a third aspect of the present invention, an estimation information management system includes a communication network; an estimation information management device connected to the communication network; a product information providing server connected to the communication network; and first and second user terminal devices connectable to the communication network.

The estimation information management device is operable to provide an estimation information ID to the first user terminal device in response to a request to issue the estimation information ID from the product information providing server, to instruct the product information providing server to provide product information to the second user terminal device in response to a request to issue the estimation information ID from the second user terminal device, and to perform incentive payment processing of the first user terminal device in response to a request to pay an incentive from the product information providing server.

Herein, the “product” is not limited to corporeal sales objects and includes all objects such as real estate and incorporeal services for sales and rental.

The product information providing server is operable to provide the product information in response to the request from the first user terminal device, when receiving a request to issue the estimation information ID from the first user terminal device, to transmit the request to issue the estimation information ID to the estimation information management device, to provide the product information to the second user terminal device in response to the instruction from the estimation information management device, and when receiving a notification indicating the purchase of the product from the second user terminal device, to request the incentive payment processing for a user of the first user terminal device.

The first user terminal device is operable to request the product information from the product information providing server, to receive and browse the product information, to issue the request to issue the estimation information ID to the product information providing server, to receive the estimation information ID from the estimation information management device, and to provide the estimation information ID and estimation comment information to the second user terminal device.

The second user terminal device is operable to request that the estimation information management device provide the product information by using the estimation information ID received from the first user terminal device, and to receive the product information from the product information providing server.

According to a fourth aspect of the present invention, an estimation information management device includes an estimation information ID issuing unit operable to issue an estimation information ID to a first user terminal device in response to a request to issue the estimation information ID from a product information providing server and to store the issued estimation information ID, information for specifying an issue requester, and information for specifying a product as an estimation target with a relationship thereamong; a product information request processing unit operable to instruct the product information providing server which handles information on a product to provide product information to a second user terminal device in response to a request to provide the product information from the second user terminal device; and an incentive information management unit operable to perform incentive payment processing for the first user terminal device in response to a request to pay an incentive from the product information providing server.

According to a fifth aspect of the present invention, a product information providing server includes an estimation information ID requesting unit operable to transmit a request to issue an estimation information ID to an estimation information management device when receiving the request from a first user terminal device; a product information request receiving unit operable to receive an instruction to transmit information on a product from the estimation information management device and to transmit the product information to a second user terminal device in response to the transmission instruction; and an incentive giving instructing unit operable to request incentive payment processing for a user of the first user terminal device when receiving information on an application to purchase the product from a second user terminal device which provides the product information.

According to a sixth aspect of the present invention, a user terminal device includes an estimation information ID requesting unit operable to issue a request to issue an estimation information ID to a product information providing server and to receive data on the estimation information ID provided by an estimation information management device in response to the request; and an estimation information providing unit operable to obtain the estimation information ID and to provide estimation comment information to another user terminal device.

According to a seventh aspect of the present invention, a method for paying an incentive in accordance with estimation information includes transmitting data on an estimation information ID to a first user terminal device; receiving a request to transmit product information corresponding to the estimation information ID from a second user terminal device; transmitting instruction information for providing the product information to the second user terminal device to a product information providing server; and receiving a request of incentive payment processing from the product information providing server.

### BRIEF DESCRIPTION OF THE DRAWINGS

FIG. 1 is a conceptual diagram showing the outline of a first business model of the present invention;

FIG. 2 is a diagram showing one example of transmitting contents and advertisement information provided for the user during viewing the contents;

FIG. 3 is a diagram showing another example of transmitting the contents and the advertisement information provided for the user during viewing the contents, unlike the transmitting example in FIG. 2;

FIG. 4 is a diagram showing an example of the structure of one user interface for displaying the contents and the advertisement information;

FIG. 5 is a diagram showing an example of the structure of another user interface for displaying the contents and the advertisement information, unlike the one user interface shown in FIG. 4;

FIG. 6 is a diagram showing an example of the structure of a contents distributing system according to a first embodiment of the present invention;

FIG. 7 is a diagram showing an example of the structure of the contents distributing system according to one modification of the first embodiment;

FIG. 8 is a diagram showing an example of the structure of the contents distributing system according to another modification of the first embodiment;

FIG. 9 is a block diagram showing an example of the structure of user authenticating means according to the first embodiment;

FIG. 10 is a diagram showing an example of recording contents of a user data recording unit according to the first embodiment;

FIG. 11 is a block diagram showing an example of the structure of contents transmitting means according to the first embodiment;

FIG. 12 is a block diagram showing an example of the structure of transmitting and recording means according to the first embodiment;

FIG. 13 is a diagram showing an example of the structure of a recorded transmission log according to the first embodiment;

FIG. 14 is a block diagram showing an example of the structure of charge calculating means according to the first embodiment;

FIG. 15 is a diagram showing an example of recording data of a payment condition recording unit according to the first embodiment;

FIG. 16 is a flowchart of an example of an operation for calculating an advertisement charge;

FIG. 17 is a diagram showing an example of a contents distributing system structure according to a second embodiment of the present invention;

FIG. 18 is a diagram showing an example of the structure of user action introducing means according to the second embodiment;

FIG. 19 is a block diagram showing an example of the structure of a charge calculating unit according to the second embodiment;

FIG. 20 is a diagram showing an example of the structure of a contents distributing system according to a third embodiment of the present invention;

FIG. 21 is a diagram showing an example of the structure of incentive processing means according to the third embodiment;

FIG. 22 is one conceptual diagram for explaining a second business model of the present invention;

FIG. 23 is another conceptual diagram for explaining the second business model of the present invention;

FIG. 24 is another conceptual diagram for explaining the second business model of the present invention;

FIG. 25 is another conceptual diagram for explaining the second business model of the present invention;

FIG. 26 is a diagram showing an example of the structure of an estimation information management system;

FIG. 27 is a block diagram showing an example of the structure of an estimation information management device;

FIG. 28 is a diagram showing an example of storing contents of an estimation information database (DB) unit;

FIG. 29 is a diagram showing an example of the storing contents of an incentive information database unit;

FIG. 30 is a diagram showing one example of the data structure of the storing contents of an estimator database unit;

FIG. 31 is a diagram showing another example of the data structure of the storing contents of the estimator database unit;

FIG. 32 is a diagram showing another example of the data structure of the storing contents of the estimator database unit;

FIG. 33 is a block diagram showing an example of the structure of a product information providing server;

FIG. 34 is a block diagram showing an example of the structure of a user terminal device;

FIG. 35 is a sequence diagram showing an example of the operation from a request for issuing an estimation information ID by the user terminal device to incentive payment processing for the user terminal device;

FIG. 36 is a diagram showing an example of the structure of a screen for receiving the issue of the estimation information ID;

FIG. 37 is a diagram showing an example of a screen for transmitting data on the estimation information ID;

FIG. 38 is a diagram showing an example of a screen for displaying the estimation information when sending the estimation information by an e-mail;

FIG. 39 is a diagram showing a display example of notification information displayed on an information provider device;

FIG. 40 is a diagram showing an example of a screen for receiving an appraisal of the estimation information;

FIG. 41 is a diagram showing an example of a screen for inputting the appraisal of the estimation information; and

FIG. 42 is a diagram showing an example of a screen for displaying the appraisal of the estimation information.

### DETAILED DESCRIPTION

### Outline of First Business Model

Prior to a description of embodiments of the present invention, the outline of a first business model (business method) of the present invention will be described.

FIG. 1 shows a conceptual diagram showing the outline of the first business model of the present invention.

In the first business model, a contents transmitting server 105 stores contents 101 created by a contents creator 103 and advertisement information 102 which an advertiser 104 desires to be viewed by a viewer. A viewer 106 accesses the contents transmitting server 105, thereby viewing the contents 101. The contents 101 and the advertisement information 102 are transmitted to the viewer 106.

In this description, the contents 101 created by the contents creator 103 are uploaded to the contents transmitting server 105 via a communication network 108 from a terminal device 111, and the advertiser 104 uploads the advertisement information 102 to the contents transmitting server 105 via the communication network 108 from a user terminal device 112. However, the contents 101 and the advertisement information 102 may not necessarily be provided for the contents transmitting server 105 via the above-mentioned route and they may be provided via another route (for example, they may be recorded to a recording medium and the recording medium may be given).

The advertiser 104 may not necessarily create the advertisement information 102 or a creator (e.g., an advertisement company) which receives a request from the advertiser 104 may create the advertisement information 102.

Herein, the contents 101 indicate information which is transmitted via the communication network 108, including digital data production and production copy (such as all products of video images, music, and games which are viewed while sitting on the seat or the like). The contents 101 may be downloaded, temporarily be recorded to a user terminal device 113, and thereafter be read. Alternatively, the contents 101 may be downloaded by streaming and may simultaneously be read.

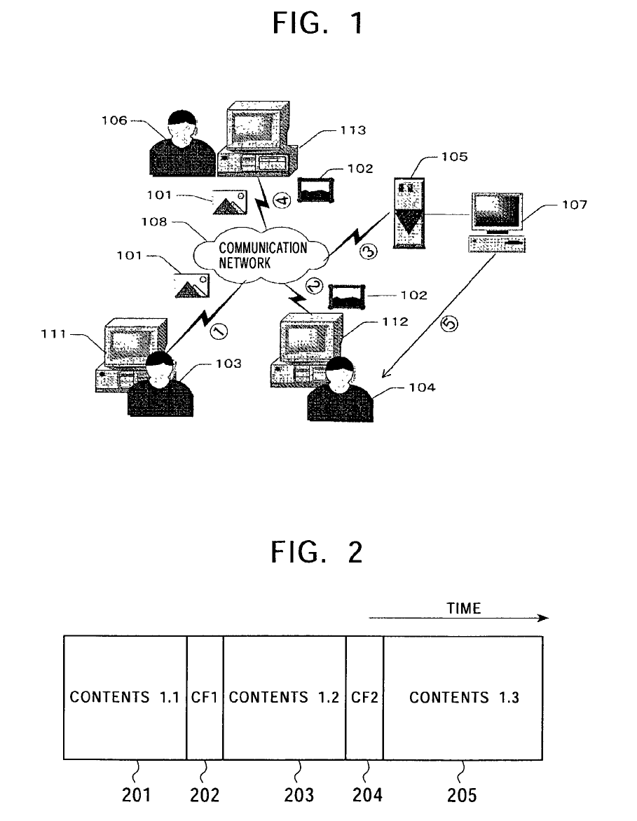

Examples of transmitting the contents 101 and the advertisement information 102 are described with reference to FIGS. 2 to 4.

FIG. 2 is a diagram showing one example of transmitting the contents and the advertisement information provided to the user during viewing the contents.

The contents include three parts 201, 203, and 205. The advertisement information includes first advertisement information 202 and second advertisement information 204. In this example, the first part 201 of the contents is first transmitted and, after ending the transmission of the first part 201, the first advertisement information 202 is transmitted. After ending the transmission of the first advertisement information 202, the second part 203 of the contents is transmitted. Similarly, the second advertisement information 204 and the third part 205 of the contents are transmitted. Then, the transmission of the entire contents ends.

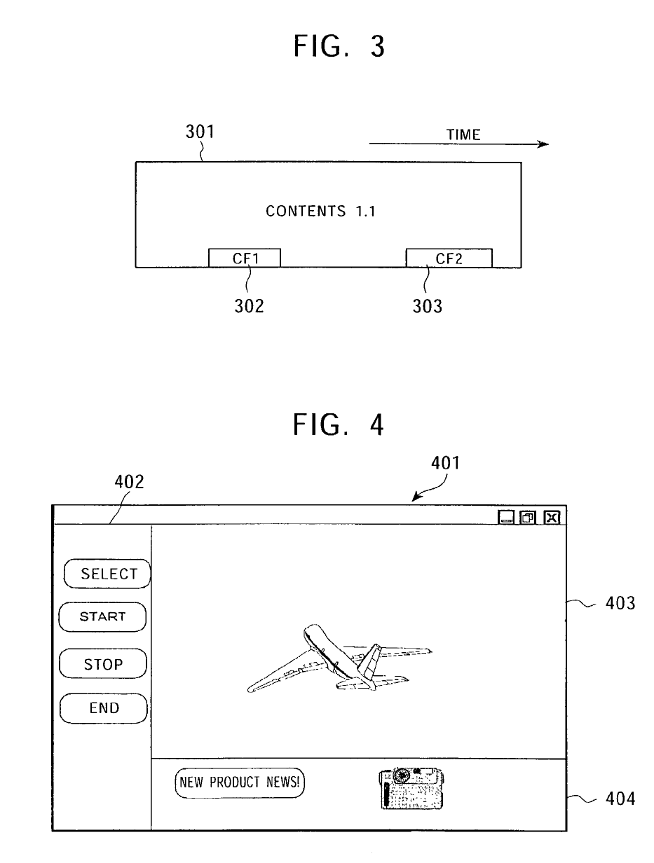

FIG. 3 is a diagram showing another example of transmitting the content and the advertisement information provided for the user during viewing the contents, unlike the transmitting example shown in FIG. 2.

In this example, contents 301 are continuously transmitted without intermission. First advertisement information 302 and second advertisement information 303 are transmitted to the viewer by using a part of the band during the transmission of the contents 301.

The first business model may be implemented by using any of the transmitting modes shown in FIGS. 2 and 3. Alternatively, another transmission mode may be used.

FIG. 4 shows an example of the structure of a user interface for displaying contents and advertisement information which are generated by the user terminal device 113 of the viewer 106.

In the example shown in FIG. 4, a window 401 displayed on display means of the user terminal device 113 (e.g., a liquid crystal display) comprises three areas. An operation area 402 is an operation panel for issuing various requests to a contents transmitting server 402 by the viewer 106. An area 403 displays the contents. An area 404 displays the advertisement information.

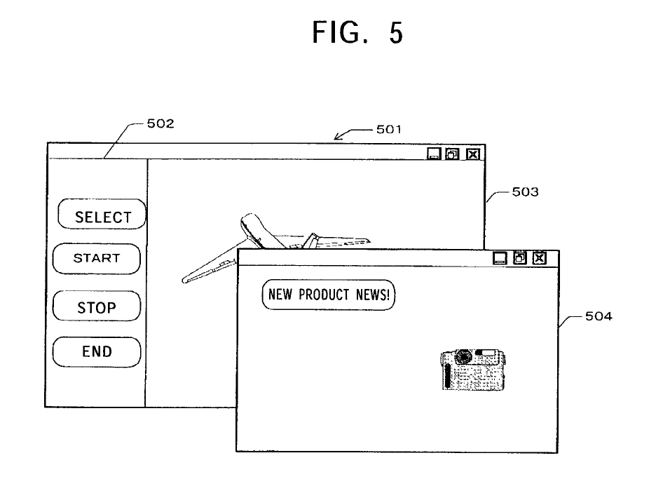

FIG. 5 shows an example of the structure of a user interface for displaying the contents and the advertisement information, unlike the user interface shown in FIG. 4.

In this example, a window 501 displayed on display means of the user terminal device 113 (e.g., a liquid crystal display) comprises two areas. An operation area 502 is an operation panel for issuing various requests to the contents transmitting server 402 by the viewer 106. An area 403 displays the contents.

The advertisement information 102 is transmitted and then a window 504 different from the window 501 is opened. The window 504 display the advertisement information and may be closed when ending the display operation of the advertisement information.

The first business model may be implemented by using any of the user interfaces shown in FIGS. 4 and 5, and may use another user interface.

Referring back to FIG. 1, the outline of the first business model will be described again.

The contents transmitting server 105 is connected to an advertisement charge processing device 107. The advertisement charge processing device 107 calculates an advertisement charge by referring to the transmission log based on a charge payment condition which is predetermined by the advertiser or the like, and is operated to provide the calculated advertisement charge for each advertiser (shown by an arrow (5)).

The contents transmitting server 105 may have a function for promoting any operation to the viewer 106 and for receiving the operation result simultaneously with the transmission of the contents or the advertisement information. For example, the contents transmitting server 102 sends information such as news of catalog presentation, questionnaire answer, and application of a prize. The viewer 106 answers the questionnaire. Thus, property information on the viewer 106 is collected and the collected property information may be provided for the advertiser 104.

Further, the contents transmitting server 105 may give incentive to the viewer having a specific advertisement viewing log so that the advertisement viewing of the viewer is promoted or it is promoted that the viewer returns an answer for news of catalog presentation, questionnaire answer, application of a prize.

For example, the advertisement viewing and the answering can be promoted by applying a profit, such as presentation of premium and gift or of points corresponding to member costs, to the viewer who views a predetermined number of pieces of the advertisement information or more within a predetermined period.

### First Embodiment

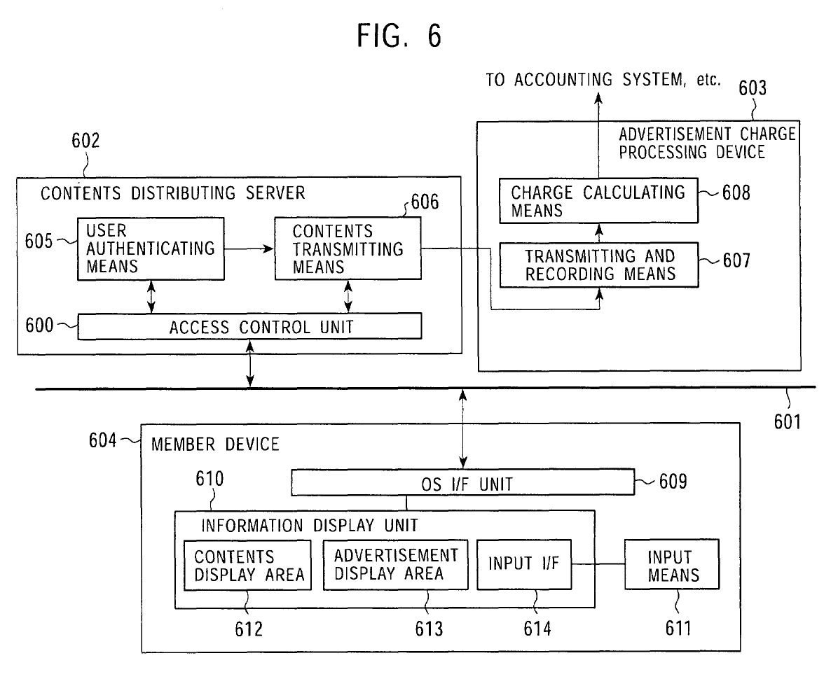

Next, a description is given of an example of the structure of the contents distributing server according to a first embodiment with reference to FIGS. 6 to 15.

FIG. 6 is a diagram showing an example of the structure of the contents distributing system according to the first embodiment.

The contents distributing system according to the first embodiment comprises a communication network 601, a contents distributing server 602 connected to the communication network 601, an advertisement charge processing device 603 connected to the contents distributing server 602, and a member device 604 connected to the communication network 601.

### [Communication Network]

On the communication network 601, information can be received and transmitted when a device connected to the communication network 601 establishes a session to a target device, irrespective of wiring, radio way, dedicated line, and exchange line. The communication network 601 may be realized by combination of a plurality of networks via a gateway such as the Internet. Or, the communication network 601 may temporarily be connected to a basic line what is called a backbone by PPP (Point to Point Protocol) connection, without directly being connected to the basic line, thereby transmitting and receiving the information to the device which establishes the session. The above-mentioned “communication network” includes a communication network which does not use any exchange device for which a dedicated line is fixedly provided.

### [Contents Distributing Server]

The contents distributing server 602 supplies the contents and the advertisement information to the member device 604 in response to a request form the member device 604, and has a function for recording the transmission log indicating which advertisement information is transmitted to which member device.

The contents distributing server 602 is an information processing device having a communication functions of a computer, a work station, or the like. The contents distributing server 602 may comprise information processing devices such as a computer or a work station, having a CPU, a main memory (RAM), a ROM, an input/output (I/O) device, a hard disk device, etc. The ROM or the hard disk device stores a program for allowing the information processing device to have a function as the contents distributing server 602. The contents distributing server 602 is realized by providing the program on the main memory and executing the program by the CPU. Then, the contents distributing server 602 executes a method for registering the collected information or a method for browsing the collected information. The program may not necessarily be stored in the storing device in the information processing device and the program may be provided from an external device, for example, an ASP (Application Service Provider) server and be provided on the main memory.

The contents distribution server 602 comprises an access control unit 600, a user authenticating means 605 connected to the access control unit 600, and contents transmitting means 606 connected to the access control unit 600 and the user authenticating means 605.

The access control unit 600 has a function for establishing the connection to the member device 604 via the communication network 601 and for executing the exchange of the information, and comprises, e.g., a protocol stack including a TCP/IP.

The user authenticating means 605 has a function for receiving and recording the property information on the user of the member device 604, and for determining whether or not it has a right to use the contents distributing server 602.

The contents transmitting means 606 has a function for supplying desired contents and the advertisement information related thereto to the member device 604 in response to the request from the member device 604.

### [Member Device]

The member device 604 has a function for issuing a request for distributing the contents to the contents distributing server 602 and for displaying the contents supplied from the contents distributing server 602 and the advertisement information related thereto.

The member device 604 is an information processing device such as a mobile phone, a computer, or a work station which can access the contents distributing server 602 via the communication network 601, a mobile communication terminal, or a PDA (Personal Digital Assistant), and may be an information processing device comprising a mobile phone having a Web connecting function and a so-called browser as Web document browsing software.

The member device 604 comprises an OS interface unit 609 for connection to the communication network 601, an information display unit 601 connected to the OS interface unit 609, and input means 611. The OS interface unit 609 has a function for establishing the connection to the contents distributing server 602 via the communication network 601 and for executing exchanging the information, and comprises, e.g., basic software (OS) including a protocol stack having a TCP/IP.

The information display unit 610 may comprise a display device, such as a liquid crystal display), for generating a contents display area 612, an advertisement display area 613, and an input interface 614 and Web document browsing software.

The information display unit 610 has a function for displaying the contents and the advertisement information which are supplied from the contents distributing server 602 and for supplying the input interface 614 for issuing various requests to the contents distributing server 602.

The input means 611 comprises an input device such as a key board or a pointing device.

### [Advertisement Charge Processing Device]

The advertisement charge processing device 603 has a function for recording the transmission log indicating which advertisement information is transmitted to which member device, for calculating the advertisement charge based on the transmission log, and for outputting the calculated advertisement charge if necessary.

The advertisement charge processing device 603 is an information processing device having a communication function of a computer or a work station. The advertisement charge processing device 603 may comprise information processing devices such as a computer or a work station, having a CPU, a main memory (RAM), a ROM, an input/output (I/O) device, and a hard disk device. The ROM or the hard disk device stores a program for allowing the information processing device to have a function as the advertisement charge processing device 603. The advertisement charge processing device 603 is realized by providing the program on the main memory and executing the program by the CPU. Then, the advertisement charge processing device 603 executes a method for registering the collected information or a method for browsing the collected information. The program may not necessarily be stored in the storing device in the information processing device and the program may be provided from an external device, for example, an ASP (Application Service Provider) server and be provided on the main memory.

The advertisement charge processing device 603 comprises transmitting and recording means 607 connected to the contents transmitting means 606 and charge calculating means 608 connected to the transmitting and recording means 607.

The transmitting and recording means 607 receives from the contents transmitting means 606, information indicating which advertisement information is transmitted to which member device, and records the received information as the transmission log.

The charge calculating means 608 calculates the advertisement charge based on the transmission log and outputs the calculated advertisement charge if necessary.

### [Modification of the System Structure]

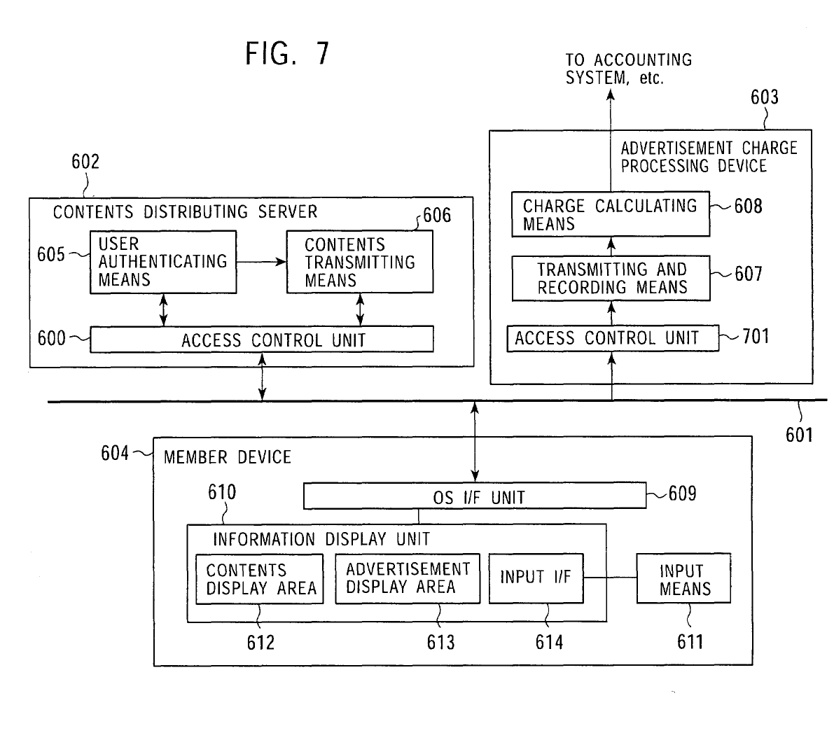

The contents distributing server 602 and the advertisement charge processing device 603 may be connected via the communication network 601. FIG. 7 shows an example of the system structure in this case. The advertisement charge processing device 603 further comprises an access control unit 701 for connection to the communication network 601.

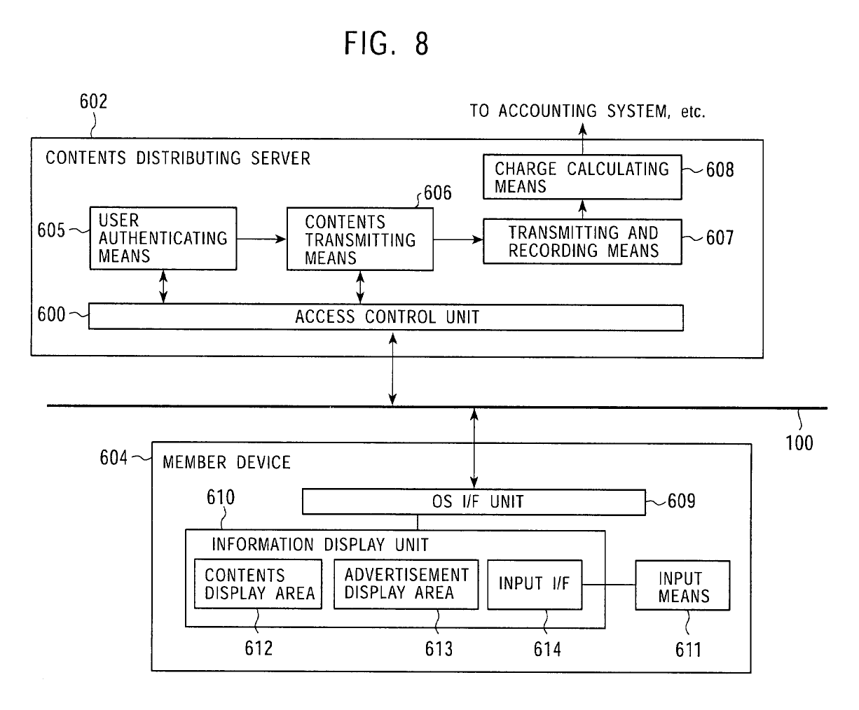

The contents distributing server 602 and the advertisement charge processing device 603 may not necessarily be structured independently, and may be integrated as a single unit. FIG. 8 shows an example of the structure in this case.

The means 605 to 608 in the contents distributing server 602 may not necessarily be provided physically as one information processing device, and may be provided in a plurality of devices on a network as distribution objects and be operated in cooperation therewith via the communication network.

### [Example of Structure of Main Components]

Next, an example of components in the present system will be described.

### [User Authenticating Means]

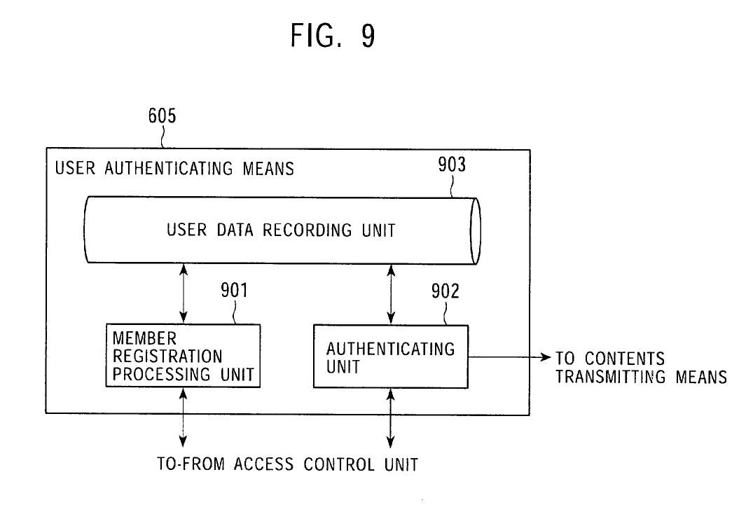

FIG. 9 is a block diagram showing an example of the structure of the user authenticating means 605.

The user authenticating means 605 comprises a member registration processing unit 901, an authenticating unit 902, and a user data recording unit 903 connected to the member registration processing unit 901 and the authenticating unit 902.

When a user who accesses the contents distributing server 602 is not registered, the member registration processing unit 901 has a function for promoting the registration and for generating and transmitting a user registering page which promotes the input of a registering index including the user property information. When the user registering page is displayed on the member device and the user inputs indexes, the user registering page is returned to the member registration processing unit 901. The returned registering indexes are written to the user data recording unit 903.

When the user accesses the contents distributing server 602, the authenticating unit 902 has a function for checking whether or not the user has an access right to the contents distributing server 602. As an example, when receiving the request for distributing the contents from the user, the authenticating unit 902 transmits a Web document for requesting a user ID and a password to the member device, and requests an input operation of the user ID and the password to the user. The user ID and the password inputted by the user are returned from the member device 604 and then the authenticating unit 902 refers to the user data recording unit 903 and checks whether or not the user ID and passwords are recorded ones. If so, the contents transmitting means 606 is started.

The user data recording unit 903 has a function for recording the user ID for identifying the user, the password, and the user property.

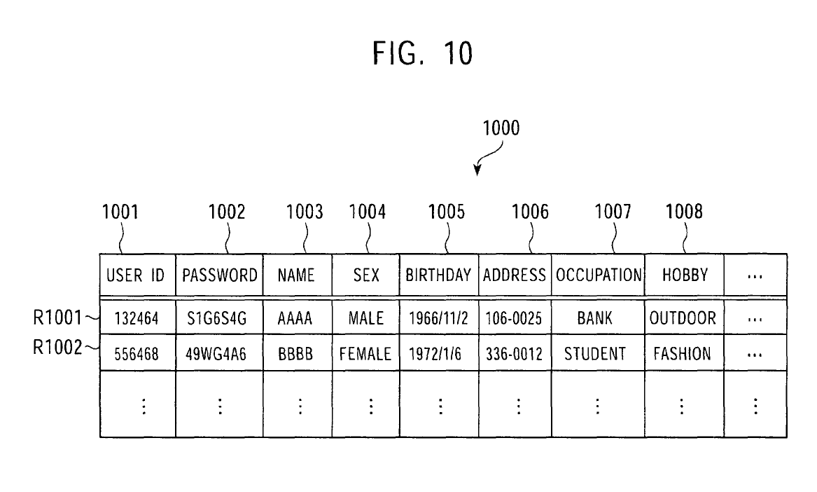

FIG. 10 shows an example of recording contents of the user data recording unit 309. In the example shown in FIG. 10, user data 1000 has one record every user. Further, the example in FIG. 10 shows the recording operation of a plurality of records R1001, R1002, . . . . The record comprises a user ID field 1001 and a password field 1002, and a name field 1003, a sex field 1004, a birthday field 1005, an address field 1006, an occupation field 1007, and a hobby field 1008 which indicate the user property information. The user ID field 1001 stores a user ID number. In the example, a user unique number is previously generated for the user ID number and is stored in the record. The password field 1002 stores the password which is determined by the user having the user ID. The name field 1003, the sex field 1004, the birthday field 1005, the address field 1006, the occupation field 1007, and the hobby field 1008 store input indexes of the corresponding user.

### [Contents Transmitting Means]

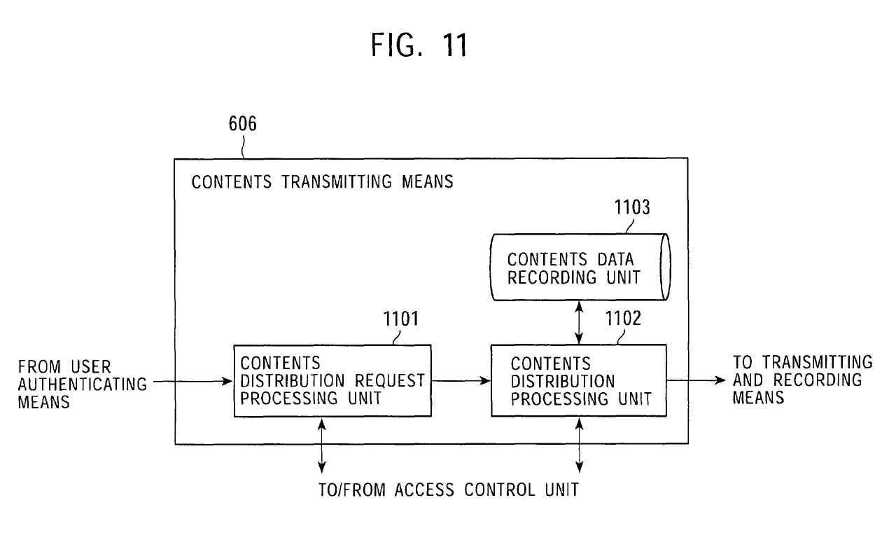

Next, an example of the structure of the contents transmitting means 606 will be described. FIG. 11 is a block diagram showing the structure of the contents transmitting means 606. In this example, the contents transmitting means 606 comprises a contents distribution request processing unit 1101, a contents distribution processing unit 1102, and a contents data recording unit 1103.

The contents distribution request processing unit 1101 is started in accordance with a message from the authenticating unit 902, and transmits a Web document for allowing the member device 604 to select the contents.

The contents distribution processing unit 1102 has a function for receiving information for specifying the contents selected by the member device 604, e.g., a URL (Uniform Resource Locator) indicating the position for storing a file of the contents, then, reading the file from the contents data recording unit 1103, and transmitting the file to the member device 604.

The contents distribution processing unit 1102 operates so that information for specifying the transmitted advertisement information such as an advertisement ID and information for specifying the user who transmits the advertisement information such as the user ID, to the transmitting and recording means 607.

The contents data recording unit 1103 has a function for storing various prepared contents and storing the advertisement information together with the contents. The advertisement information transmitted together with the contents may previously be collected in a single file or may be provided as an individual file, and my be transmitted by properly combining the files.

### [Transmitting and Recording Means]

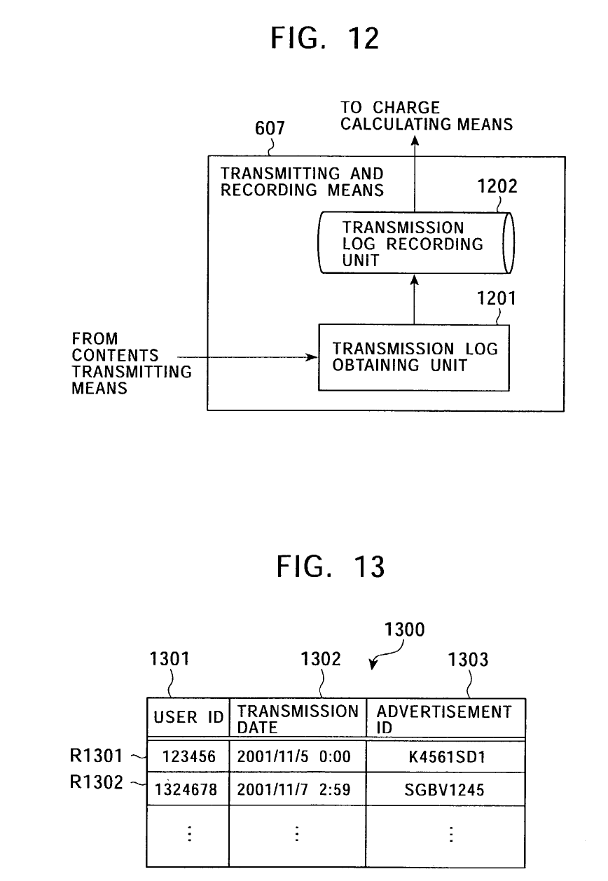

Next, the structure of the transmitting and recording means 607 will be described. FIG. 12 is a block diagram showing an example of the structure of the transmitting and recording means 607. Referring to FIG. 12, the transmitting and recording means 607 comprises a transmission log obtaining unit 1201 and a transmission log recording unit 1202.

The transmission log obtaining unit 1201 has a function for receiving both information for specifying the user who transmits the information for specifying the advertisement information (user ID) and its advertisement information, and for writing both the information, as the transmission log, to the transmission log recording means 1202.

The transmission log recording unit 1202 has a function for recording the transmission log. FIG. 13 is a diagram showing an example of the structure of the recorded transmission log. Referring to FIG. 13, a transmission log 1300 has a records R1301, R1302, every transmission of single advertisement information. The record has a user ID field 1301 for storing the user ID of the user as the transmission destination of the advertisement information, a transmission date field 1302 for storing the transmission time, and an advertisement ID 1303 for storing the advertisement ID for specifying the transmitted advertisement.

### [Charge Calculating Means]

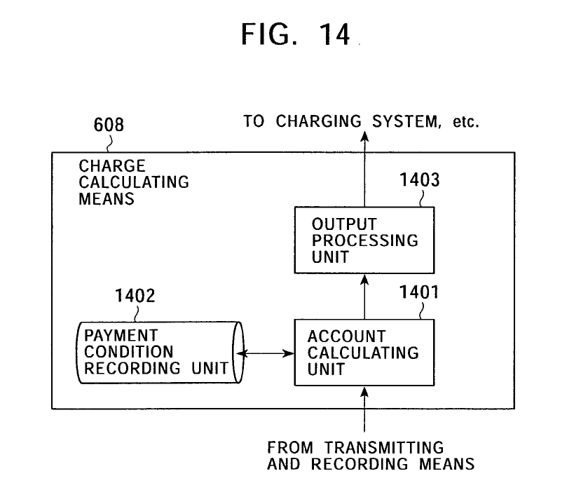

Next, an example of the structure of the charge calculating means 608 will be described. FIG. 14 is a block diagram showing the example of the structure of the charge calculating means 608. Referring to FIG. 14, the charge calculating means 608 comprises an account calculating unit 1401, a payment condition recording unit 1402, and an output processing unit 1403.

The account calculating unit 1401 has a function for referring to the transmission log recorded to the transmitting and recording means 607 and a payment condition recorded to the payment condition recording unit 1402, and for calculating the account as an advertisement charge to the advertiser.

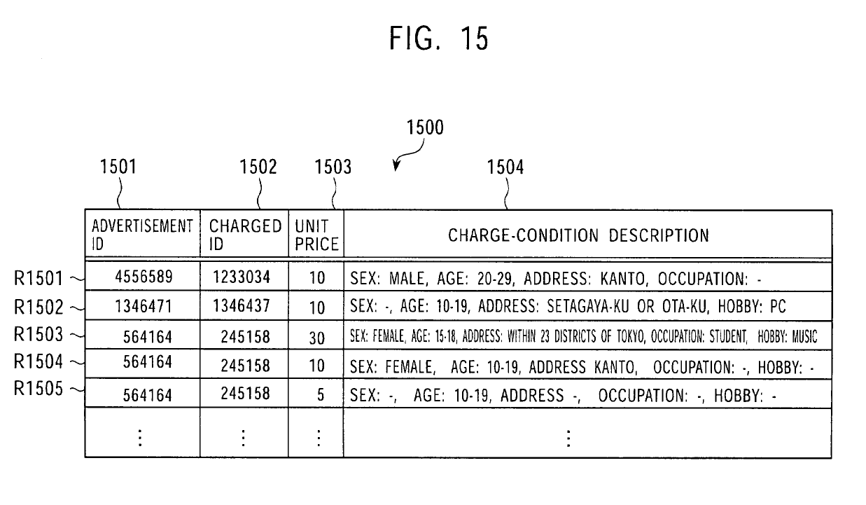

The payment condition recording unit 1402 has a function for recording the amount of payment as the advertisement charge and the payment condition for the advertiser. Preferably, the payment condition is previously inputted based on an agreement to the advertiser. FIG. 15 shows an example of recording data of the payment condition recording unit 1402. Referring to FIG. 15, recording data 1501 has records R1501, R1502, R1503, R1504, R1505, every payment condition. The record has an advertisement ID field 1501, a charged ID field 1502, a unit-price field 1503, a charge-condition description field 1504, etc.

The advertisement ID field 1501 stores information for specifying the advertisement. The charged ID field 1502 stores information for specifying the advertiser or the like as the charged destination of the advertisement. The unit-price field 1503 stores the advertisement charge which can be charged each time at which the payment condition is satisfied. The charge-condition description field 1504 stores the payment condition.

For example, the record R1501 indicates the payment condition under which an advertisement charge of 10 yen is charged every transmission of the advertisement specified by an advertisement ID “4556589” to a male of 20 to 29 ages in Kanto area. Incidentally, the advertisement payment is not required for the advertisement distribution which does not satisfy the condition described in the charge-condition description field. When the transmission log indicates that the total number of distribution times of the advertisement ID “4556589” is 10,000 and the number of matching to the payment condition described in the charge condition description field is 3,000, (charge amount 3,000 yen=300 cases×unit price 10 yen) is charged to an charged ID “1233034”. Therefore, the advertiser does not need to pay the advertisement charge of the advertisement transmitted to a user other than all the target users.

The record R1501 indicates the payment indication that the advertisement charge of 10 yen is charged every transmission of the advertisement information specified by an advertisement ID “1346471” to male and female of 10 to 19 ages having a hobby of PC in Ota district or Setagaya-district.

According to the first embodiment, an advertisement charge system can be structured, in which the higher advertisement charge can be set depending on the user near the advertisement target. The records R1503, R1504, and R1505 store the payment condition of the same advertisement information. The record R1503 indicates the payment condition of the user who is considered as a most important advertisement target by the advertiser and also indicates the unit price of 30 yen. The record R1504 indicates the payment condition of the users who are considered as a second advertisement target by the advertiser, and also indicates that the unit price is 10 yen. Further, the record R1505 indicates the payment condition of the user who is considered as a third advertisement target by the advertiser, and also indicates that the unit prices is 5 yen.

By the above operation, the advertiser can determine the advertisement charge depending on the important user as the advertisement target.

Referring back to FIG. 14, the output processing unit 1403 receives data on the advertisement charge from the account calculating unit 1401 and outputs the charge data for presenting the advertisement charge to the advertiser by using the received data. The charge data may be in appropriate formats depending on charging methods. For example, when the charge data as a bill is transmitted to the advertiser, the advertiser may transmit print data to a printer or may be outputted in a data format suitable to a transfer system of a bank, etc. upon sending the charge data to the transfer system.

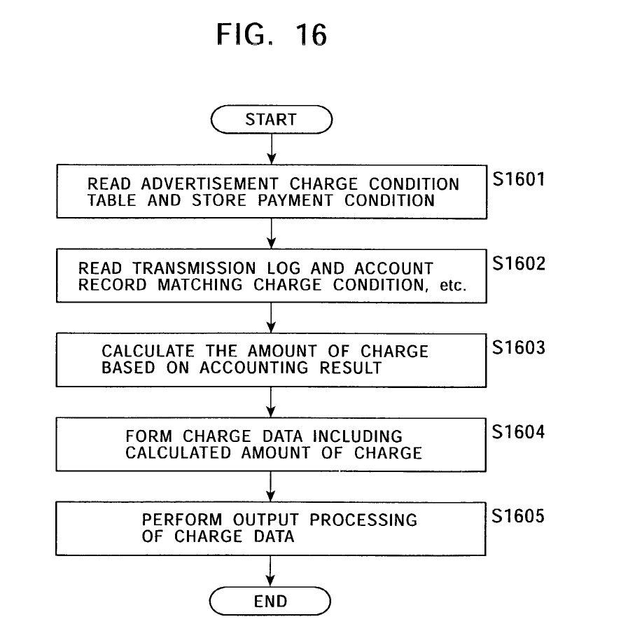

Next, a description is given of an operation for calculating the advertisement charge in the contents distributing system with reference to FIG. 16. FIG. 16 is a flowchart of an example of the operation for calculating the advertisement charge.

First, the charge calculating means 608 reads one record of the payment condition recording unit 1402 and stores the contents (step 1601).

Next, the charge calculating means 608 reads the transmission log from the transmitting and recording means 607 and counts the number of records of the transmission log which matches the contents of the record (step 1602)

Subsequently, the charge calculating means 608 calculates the amount of charge by multiplying the unit price by the counting result (step 1603).

The charge calculating means 608 forms the charge data including the calculating amount of charge (step 1604). The charge data may be digital data or print data, depending on the output destination.

Finally, the charge calculating means 608 performs the output processing of the charge data (step 1605). When sending the charge data to the transfer system in banks, the charge data is processed and outputted to data in a data format which can be received by the transfer system. When charging the advertiser by sending the bill by post, etc., the charge data may be transmitted and printed out. Other appropriate output methods of the charge data can be selected in accordance with the charging method.

### Advantages of First Embodiment

The above-mentioned contents distributing system according the first embodiment has the following advantages.

### <Merits of the Advertiser>

Since the advertisement cost corresponding to the advertisement viewing amount is paid without fail, the advertiser effectively uses the advertisement cost. Since the advertiser accurately grasps the viewing status of a program by referring to the transmission log, the program as the advertisement target can easily be determined.

### <Merits of Operator and Manager of Contents Distributing System>

An operator and an manager of the contents distributing system obtain the advertisement charge having the higher unit-price with additional information.

### Second Embodiment

Next, a second embodiment of the present invention will be described.

According to the second embodiment, an interactive communication function between the user and the contents distributing system is used, a user action for the advertisement viewing operation is promoted, and an operation history of the user actions in accordance with the promotion is collected. Then, the advertiser receives an output of a report indicating the operation result based on the user data (if the action promoted to the user indicates the request for the catalog, a list collecting address and name of the user which desires the catalog). The advertiser can further promote sales based on the report indicating the operation result. The charge of the report indicating the operation result can be accounted as a sales promotion cost or a cost other than the advertisement cost can be applied as the charge of the report indicating the operation result.

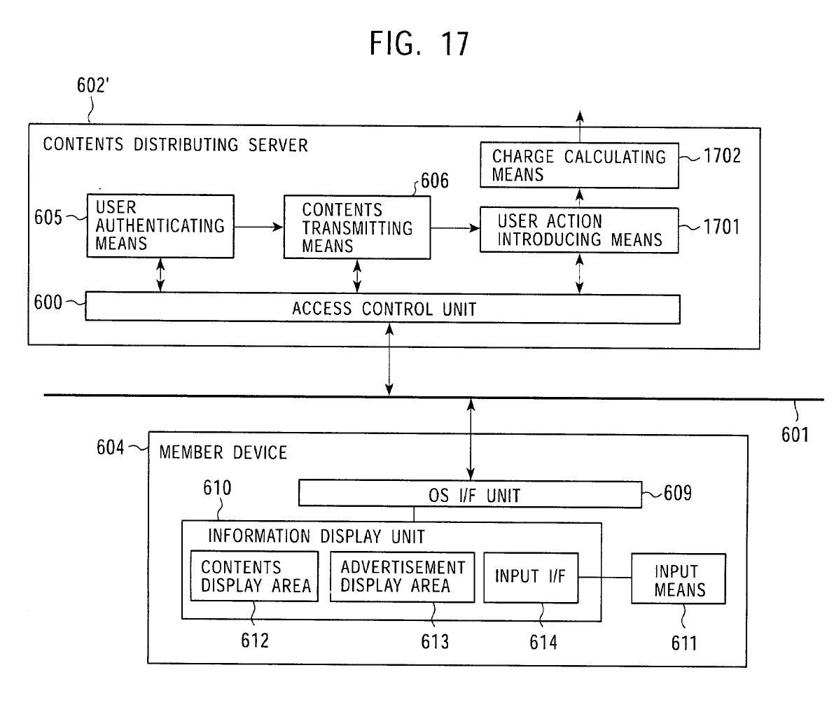

FIG. 17 shows an example of the structure of the contents distributing system according to the second embodiment. The structure of the contents distributing system according to the second embodiment is basically the same as that according to the first embodiment. However, differently, a contents distributing server 602′ comprises user action introducing means 1701 and charge calculating means 1702 connected thereto. Although not shown in FIG. 17, the contents distributing server 602′ may comprise the advertisement charge processing device 603 or may have the structure in which the contents distributing server 602 comprises the transmitting and recording means 607 and the charge calculating means 608.

FIG. 18 shows an example of the structure of the user action introducing means 1701. The user action introducing means 1701 comprises an introducing information transmitting unit 1801, an introducing information recording unit 1802, a user action information receiving unit 1803, and a user action recording unit 1804.

The introducing information transmitting unit 1801 has a function for receiving a notification of the advertisement information transmitted from the contents transmitting means, for reading introducing information corresponding to the advertisement from the introducing information recording unit 1802, and for transmitting the read introducing information to the member device 603 of the user who receives the advertisement information. The introducing information contains a message indicating that “You will get detailed information of the product on the advertisement.”, a Web document having a button object for allowing the user to issue the request, and the like. A Web document for promoting the input of an address and a name as a catalog transmission destination may be transmitted by activating the button object through a click operation.

The user action information receiving unit 1803 has a function for receiving information indicating whether or not which user performs an action such as a charging action in response to the introducing information, for receiving information (such as the address and the name in this example) provided by the user in accordance with the introducing information, and for recording the received information to the user action recording unit 1804. When obtaining the user property information such as the address and the name, the additional user property information may be transmitted to the user authenticating means and the user data may be updated.

The user action recording unit 1804 has a function for receiving information whether or not the user performs an action such as a charging action in response to the introducing information, and for recording the information provided by the user in accordance with the introducing information.

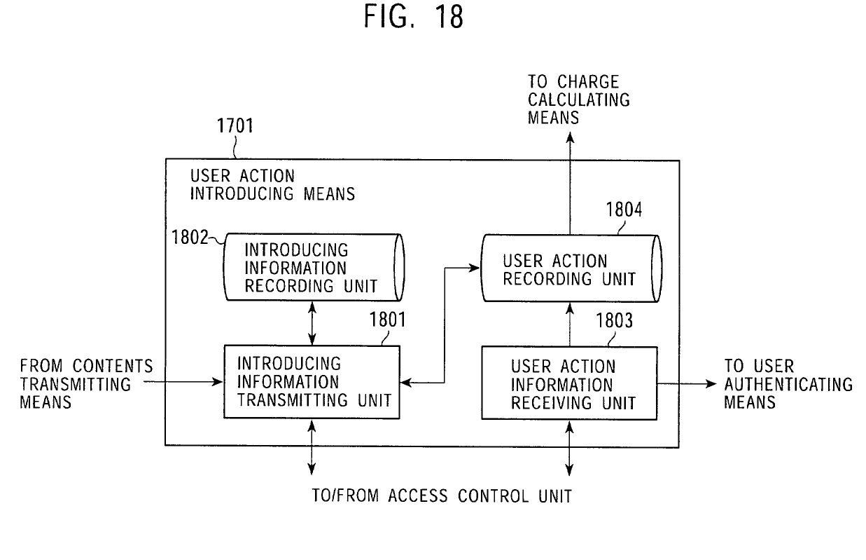

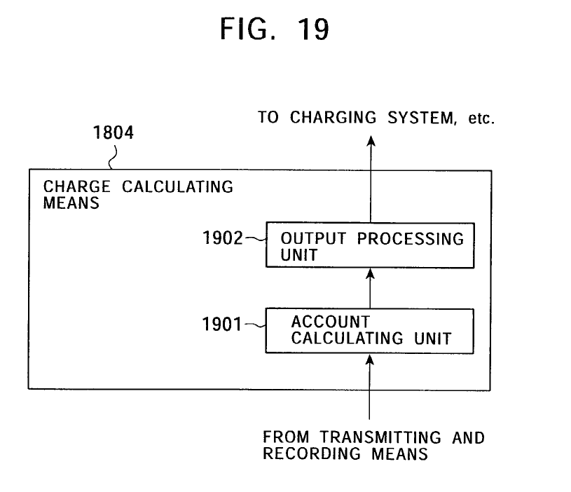

Next, a description is given of an example of the structure of the charge calculating unit 1804 with reference to FIG. 19. FIG. 19 is block diagram showing the example of the structure of the charge calculating unit 1804. The charge calculating unit 1804 comprises an account calculating unit 1901 and an output processing unit 1902.

The account calculating unit 1901 has a function for calculating the amount of account as an advertisement charge to the advertiser by referring to information on the user action history recorded to the user action information recording unit 1804.

The output processing unit 1902 receives data on the advertisement charge from the account calculating unit 1901 and outputs the charge data for presenting the amount of advertisement charge to the advertiser by using the received data on the advertisement charge. The charge data may be in any appropriate format depending on charging methods. For example, when sending a bill indicating the charge data to the advertiser, the charge data as print data may be transmitted to a printer. Alternatively, when sending the charge data to a transfer system in banks or the like, the charge data may be outputted in a data format matching the transfer system.

The output processing unit 1902 has a function for outputting a search report by referring to the information on the user action history.

### Advantages of the Second Embodiment

According to the second embodiment, the information on the user can be collected simultaneously with the transmission of the advertisement information and the detailed user data can be stored. The sales promotion cost can be paid by providing the collected user data for the advertiser as data for sales promotion.

The system of the user operation can be added to the advertisement and thus can be used as a tool for sales promotion and marketing which advance rather than the advertisement. Easily, the catalog can be applied and the user can participate in the prize.

### Third Embodiment

Next, a third embodiment of the present invention will be described.

The information is collected by promoting any action to the user according to the second embodiment. However, any action cannot be performed during the user's viewing of the contents if there is no incentive.

According to the third embodiment, the user having a specific advertisement viewing log (including the transmission log and the information on the user action history) receives a profit as a motivation for action (hereinafter, referred to “incentive”).

As an example of the incentive, a point for exchange of products and allocation to a member cost can be given to the user.

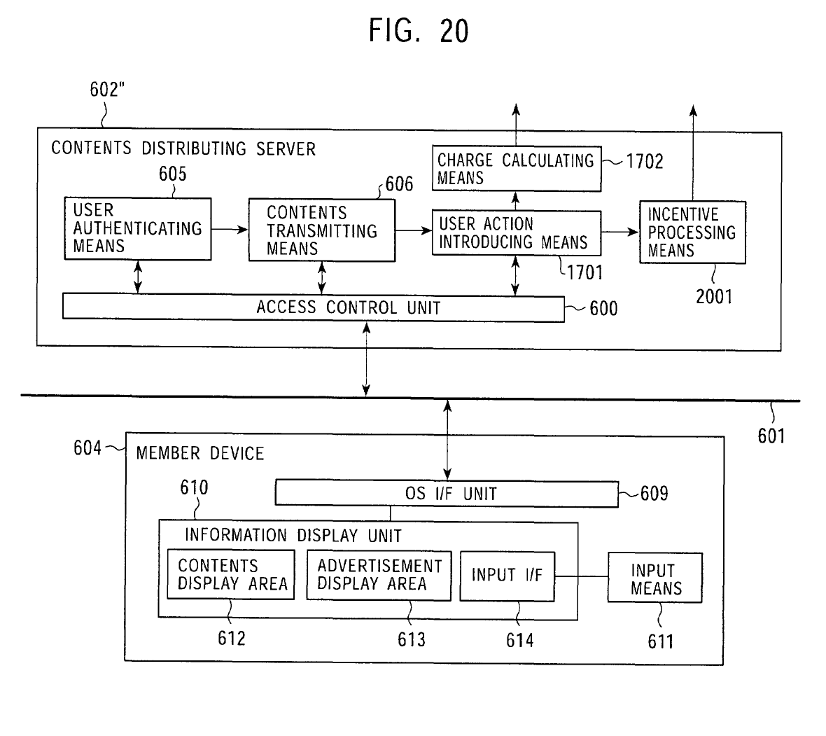

FIG. 20 shows an example of the structure of a contents distributing system including a contents distributing server 602″ according to the third embodiment. The contents distributing server 602″ is basically the same as the contents distributing server 602′ according to the second embodiment. However, unlike the contents distributing server 602′, the contents distributing server 602″ further comprises incentive processing means 2001.

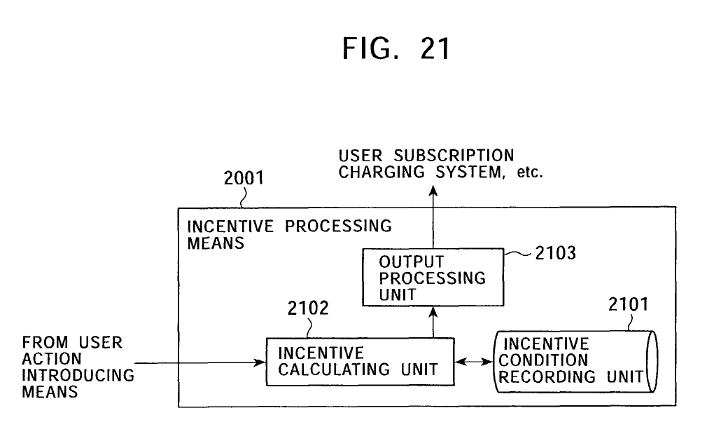

FIG. 21 shows an example of the structure of the incentive processing means 2001. The incentive processing means 2001 comprises an incentive condition recording unit 2101, an incentive calculating unit 2102, and an output processing unit 2103.

The incentive condition recording unit 2101 has a function for recording a condition for incentive to the user.

The incentive condition includes the reception of the distribution of a predetermined pieces of the advertisement information within a predetermined term, the issue of a predetermined times of the questionnaire response within a predetermined term, and the like.

The incentive calculating unit 2102 calculates the amount of incentives added to the user by referring to the record of the user action and the transmission log and by referring the incentive condition.

The output processing unit 2103 generates and outputs output data based on the amount of incentives calculated by the incentive calculating unit 2102.

With the above-mentioned structure, the motivation to the advertisement viewing and the user action can be given to the user and the user's active advertisement viewing and the execution of the user action can be promoted.

Thus, the user can obtain another incentive in free program viewing in the case of the advertisement viewing.

The advertisement necessary for the user operation enables the participation of many users.

The use of the incentive point enables the increase in using opportunities of contents with charges.

### [Outline of Second Business Model]

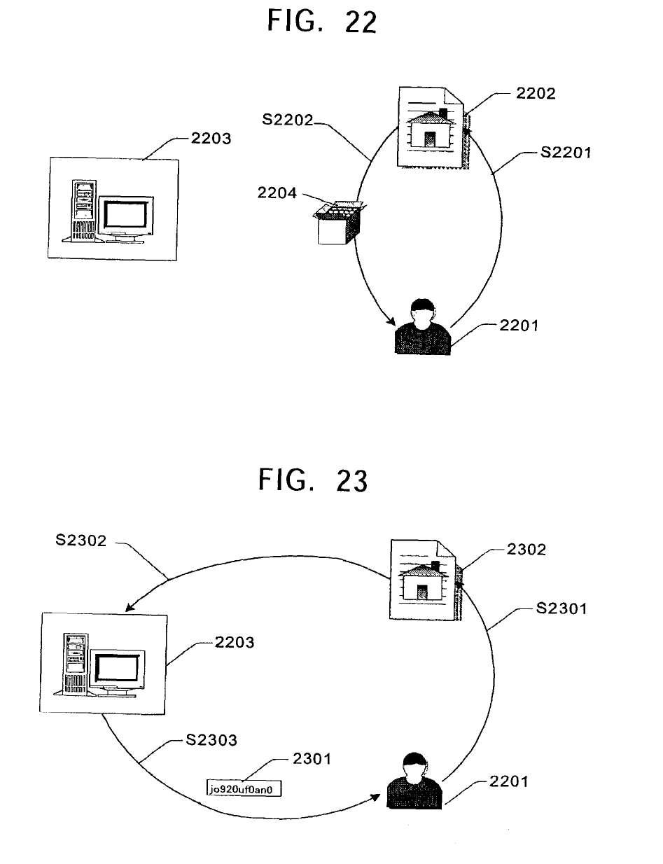

Prior to a description of embodiments of a second business model (second business method) of the present invention, an example of the second business model will be described with reference to FIGS. 22 to 25. FIGS. 22 to 25 are conceptual diagrams for explaining examples of the second business model according to embodiments of the present invention.

Referring to FIG. 22, an information provider 2201 accesses a sales site 2202 (step S2201), buys a product 2203, and receives it (step S2202).

Subsequently to FIG. 22, referring to FIG. 23, the information provider 2201 uses the received product 2203, thereafter accesses the sales site 2202 to provide his remark and estimation (hereinafter, referred to as estimation information) on the product 2203 for another user, and requests the issue of identification information (hereinafter, referred to an estimation information ID) of the estimation information (step S2301). The sales site 2202 receives the request of the issue, then, accesses an estimation information management device 2203, and transmits the request for issuing the estimation information ID and product information (hereinafter, referred to as a product ID) as information indicating a product estimated by an information provider 2201 to the estimation information management device 2203 (step S2302). The estimation information management device 2203 receives the request and then issues and provides the estimation information ID 2301 to the information provider 2201 (step S2303).

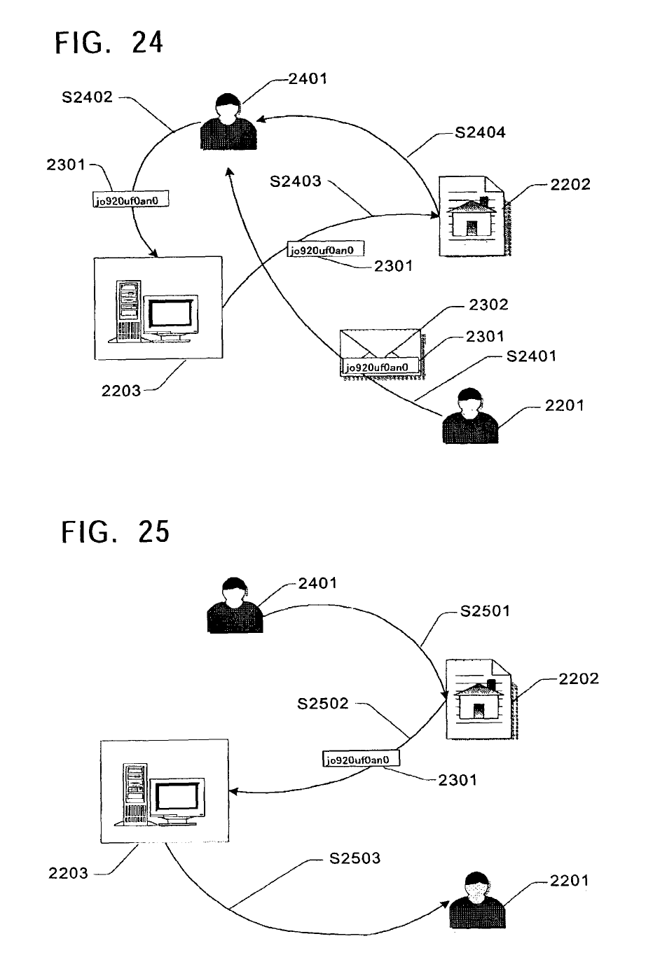

Subsequently to FIG. 23, referring to FIG. 24, the information provider 2201 transmits estimation information 2302 including his remark and comment and the estimation information ID 2301 to a buyer 2401 (step S2401). The buyer 2401 reads estimation information 2302, when he is interested in the product 2203 as a target of the estimation information 2302, transmits the estimation information ID 2301 to the estimation information management device 2203, and requests information on the product 2203 (step S2402). The estimation information management device 2203 instructs the sales site 2202 as an information providing destination of the product 2203 to provide the information on the product 2203 to the buyer 2401 (step S2403). Further, the estimation information management device 2203 sends a notification indicating that the estimation information ID 2301 is provided. The sales site 2202 which receives the instruction provides the information on the product 2203 to the buyer 2401 in response to the instruction and promotes the purchase of the product 2203 (step S2404). The buyer 2401 browses the provided information on the product 2203 and considers the purchase of the product 2203.

Subsequently to FIG. 24, referring to FIG. 25, when the buyer 2401 is interested in the product 2203 as a consideration result, he applies the purchase of the product 2203 to the sales site 2202 (step S2501). The sales site 2203 which receives the application performs processing for transmitting the product 2203 and for charging the price, and requests the estimation information management device 2203 to execute the payment of an incentive of the estimation information ID 2301 (step S2502). The estimation information management device 2203 which receives the request pays a predetermined incentive to the information provider 2201 as a person who requests the issue of the estimation information ID 2301 (step S2503). The incentive may be paid by money, or may be given as a product exchange point, or may be provided by any other profit.

A system for estimating the information provider may be introduced to know whether or not the information provider is reliable. A chance for estimating the estimation information provided by the information provider may be given to the buyer who uses the estimation information and the estimation result may be used as an estimation of the information provider by another user. A user who first knows the estimation information refers to past estimations and determines the reliability of the estimation information. It is expected that the information provider tries to provide better estimation information to obtain the incentive, thus improving the quality of the estimation information. According to the second business model, the incentive is given not only to the information provider but also to the buyer as a consumer who buys the product by using the estimation information in a form of “introduction from a heavy user” with sales discount or the like. As mentioned above, the system is advantageous for the information provider and the buyer as the consumer and thus the estimation information can increasingly be used.

### [Advantages of Second Business Model]

The incentive is given to the estimation information such as word-of-mouth information, thus widening a network of the estimation information and establishing a product sales promoting method in place of the advertisement.

The critical user to a specific product category affects many people as a charisma user, thus contributing to the increase in consumption.

### Fourth Embodiment

A fourth embodiment of the present invention will be described herein below.

### [Example of System Structure]

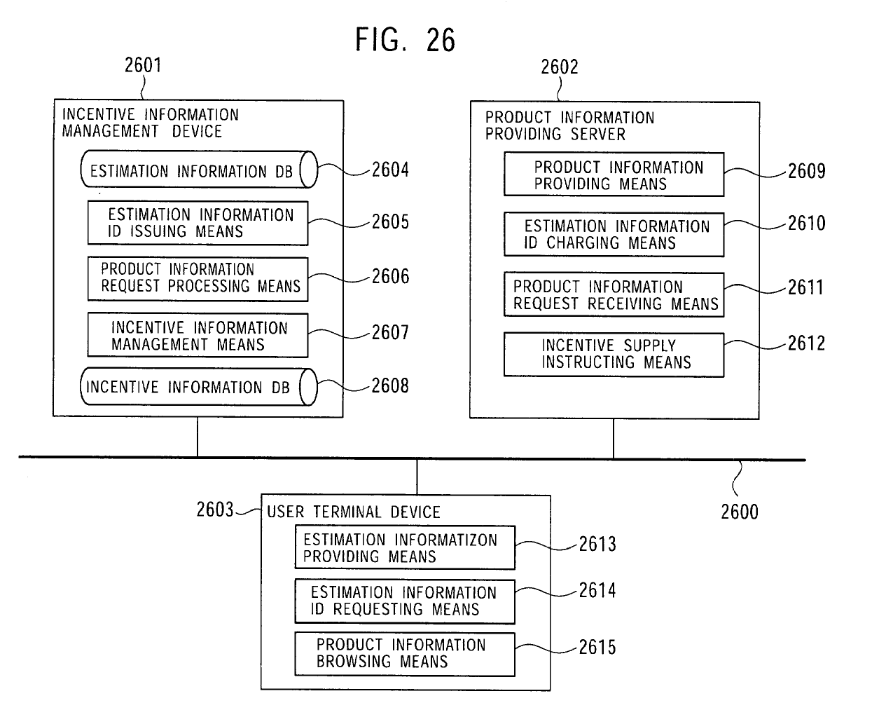

According to the fourth embodiment of the present invention, a system for implementing the second business model (hereinafter, referred to as an estimation information management system) is provided. FIG. 26 shows an example of the structure of the estimation information management system.

Referring to FIG. 26, the estimation information management system comprises an estimation information management device 2601 connected to a communication network 2600, a product information providing server 2602 connected to the communication network 2600, and a user terminal device 2603 connectable to the communication network 2600.

### [Communication Network]

On the communication network 2600, information can be received and transmitted when a device connected to the communication network 2600 establishes a session to a target device, irrespective of wiring, radio way, dedicated line, and exchange line. The communication network 2600 may be realized by combination of a plurality of networks via a gateway such as the Internet. Or, the communication network 2600 is temporarily connected to a basic line what is called a backbone by PPP (Point to Point Protocol) connection, without directly being connected to the basic line, thereby transmitting and receiving the information to the device which establishes the session. The above-mentioned “communication network” includes a communication network which does not use any exchange device for which a dedicated line is fixedly provided.

The estimation information management device 2601 provides an estimation information ID to the first user terminal device 2603 in response to a request for issuing the estimation information ID from the product information provider 2602, instructs the product information providing server 2602 to provide the product information to the second user terminal device 2603 in response to a request for providing the product information from the second user terminal device 2603, and performs incentive payment processing of the first user terminal device in response to a request for paying the incentive from the product information providing server 2602. The estimation information management device 2601 provides appraisal information of the estimation information in response to the request from the second user terminal device 2603.

The estimation information management device 2601 comprises a CPU, a main memory (RAM), a ROM, an input/output (I/O) device, an external storing device of a hard disk device, etc., and is, e.g., an information processing device such as a computer or a work station. The ROM or the hard disk device stores a program for allowing the information processing device to have a function as the estimation information management device 2601. The estimation information management device 2601 is realized by providing the program on the main memory and executing the program by the CPU. Then, the estimation information management device 2601 executes a method for registering the collected information or a method for browsing the collected information. The program may not necessarily be stored in the storing device in the information processing device and the program may be provided from an external device, for example, an ASP (Application Service Provider) server and be provided on the main memory.

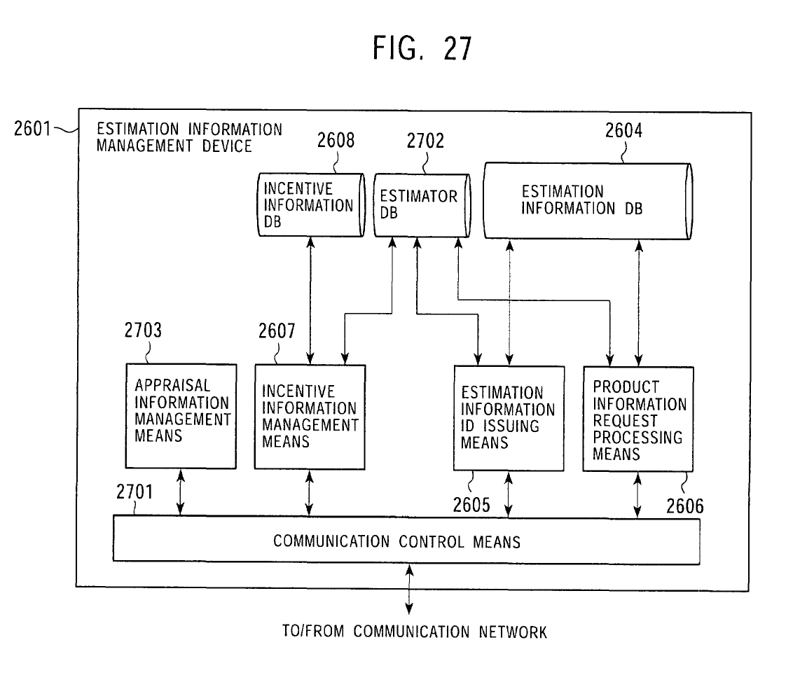

FIG. 27 is a block diagram showing an example of the structure of the estimation information management device 2601. The estimation information management device 2601 comprises communication control means 2701, product information request processing means 2606, estimation information ID issuing means 2605, incentive information management means 2607, appraisal information management means 2703, an estimation information database (hereinafter, referred to DB) unit 2604, an incentive information DB unit 2608, and an estimator DB unit 2702.

The communication control means 2701 has a function for receiving information from the communication network 2600 and for transmitting the information to the communication network 2600, and is, e.g., a front end communication processor comprising a CPU for executing a protocol stack and a predetermined communication sequence in accordance with the protocol stack.

The estimation information ID issuing means 2605 provides the estimation information ID to the user terminal device 2603 in response to the request for issuing the estimation information ID from the product information providing server 2602. Further, the estimation information ID issuing means 2605 stores the issued estimation information, information for specifying a requester of the issue (estimator) (hereinafter, referred to as an estimator ID), and information for specifying the product as an estimation target (hereinafter, referred to a product ID) in the estimation information DB unit 2604 with a corresponding relationship thereamong.

The product information request processing means 2606 instructs the product information providing server 2602 which handles the product information, to provide the product information to the user terminal device 2603 in response to the request for providing the product information from the user terminal device 2603.

The incentive information management means 2607 performs the incentive paying processing of the first user terminal device 2603 in response to the request for paying the incentive from the product information providing server 2602. The incentive paying processing is performed by writing the information to the incentive paying DB unit 2608.

The appraisal information management means 2703 provides the appraisal information of the estimation information in response to the request from the user terminal device 2603.

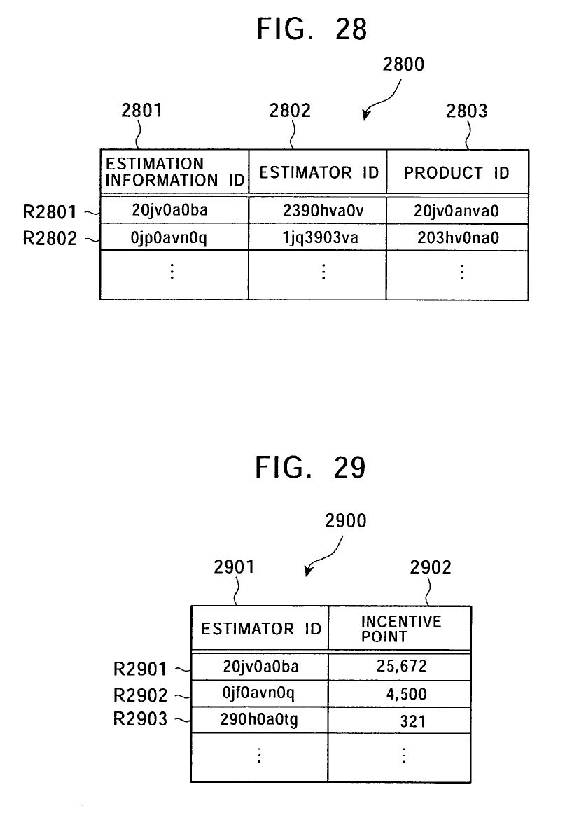

The estimation information DB unit 2604 stores the estimation information ID, an estimator ID as information for specifying the requester of the issue (estimator), and the product ID as information for specifying the product as the estimation target with a relationship thereamong. FIG. 28 is a diagram showing an example of the storing contents of the estimation information DB unit 2604. In this example, the estimation information DB unit 2604 stores the information as an estimation information table 2800. The estimation information table 2800 has records R2801, R2802, . . . every estimation information ID. The record comprises an estimation information ID field 2801, an estimator ID field 2802 for storing the information of the user who requests the issue of the estimation information ID, and a product ID field 2803 for storing the information for specifying the product as the estimation target.

The estimator and the product as the estimation target can be specified by referring to the storing contents of the estimation information DB unit 2604 and then by receiving the estimation information ID.

The incentive information DB unit 2608 stores information indicating how incentive is paid to which estimator. FIG. 29 is a diagram showing an example of the storing contents of the incentive information DB unit 2608. In this example, the incentive information DB unit 2608 stores the information as an incentive information table 2900. The incentive information table 2900 has records R2901, R2902, R2903, every estimator. The record comprises an estimator ID field 2901 and an incentive point field 2903 for storing the sum of the incentive values given to the estimator.

It is known by referring to the storing contents of the incentive information DB unit 2608 that the user as the estimator has the sum of the incentive values.

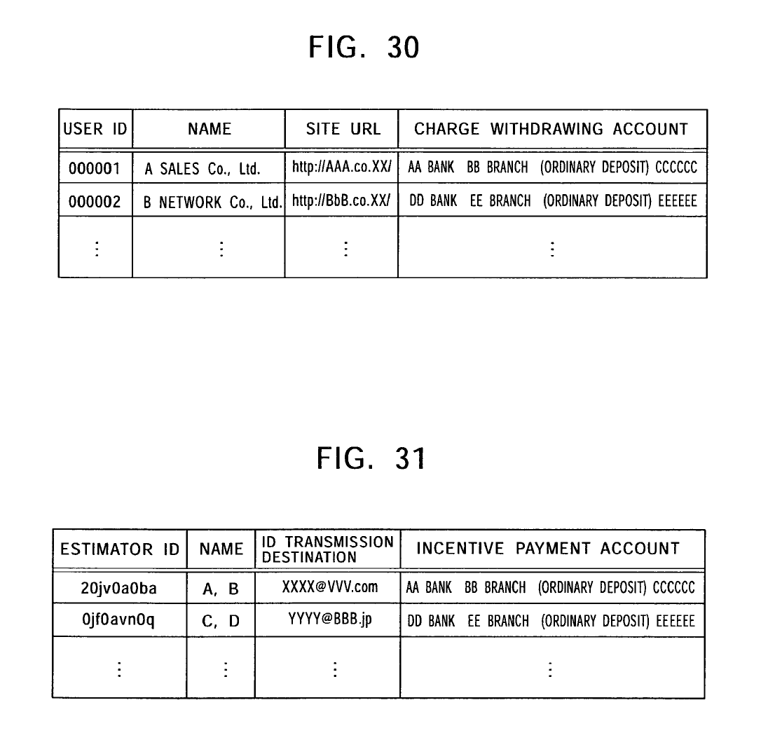

The estimator DB unit 2702 stores information on the product information providing server 2602 or an operator thereof, the estimator, and the product ID. FIG. 30 shows an example of the data structure of the information on the product information providing server 2602 stored by the estimator DB unit 2702 or the operator thereof. FIG. 31 shows an example of the data structure of the information on the estimator stored in the estimator DB unit 2702. FIG. 32 shows an example of the data structure of the information for specifying the product information providing server 2602 which handles the product, as information on the product ID stored in the estimator DB unit 2702. The product information request processing means 2606, the estimation information ID issuing means 2605, and the incentive information management means 2607 are operated by referring to the storing contents of the estimation information DB unit 2604 and the incentive information DB unit 2608 and the storing contents of the estimator DB unit 2702, and, for example, they are used for specifying an address of the product information providing server 2602 for providing the product information from the product ID.

### [Product Information Providing Server]

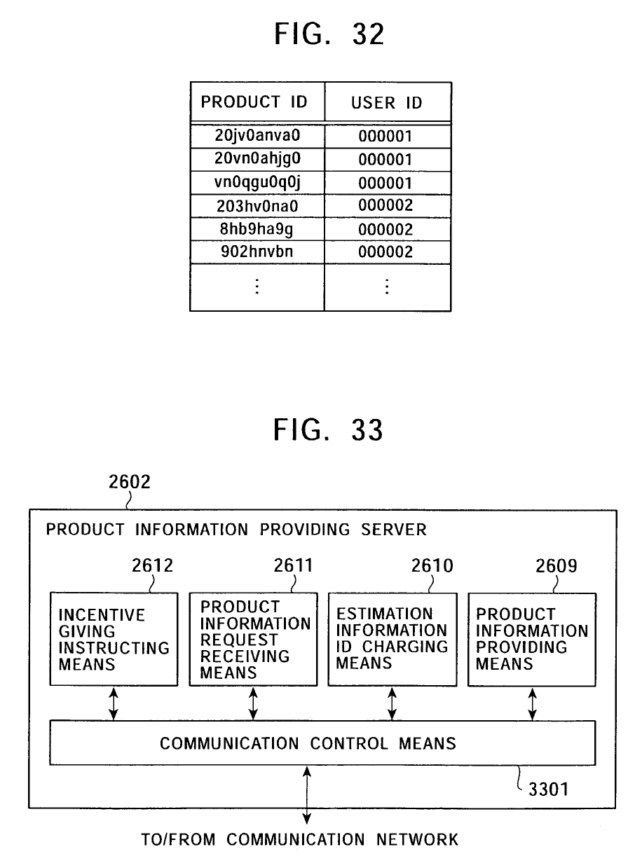

Next, a description is given of the product information providing server 2602 with reference to FIG. 33. FIG. 33 is a block diagram showing an example of the structure of the product information providing server 2602.

The product information providing server 2602 provides the product information in response to the request from the first user terminal device 2603. When receiving the request for issuing the estimation information ID from the first user terminal device 2603, the product information providing server 2602 transmits the request for issuing the estimation information ID to the estimation information management device 2601, and provides the product information to the second user terminal device 2603 in response to the instruction from the estimation information management device 2601. When receiving information indicating that the product is purchased from the second user terminal device 2604 which provides the product information, the product information providing server 2602 requests the estimation information management device 2601 to perform the incentive paying processing of the user of the first user terminal device 2603.

The estimation information providing server 2602 comprises a CPU, a main memory (RAM), a ROM, an input/output (I/O) device, an external storing device of a hard disk device, etc., and is, e.g., an information processing device such as a computer or a work station. The ROM or the hard disk device stores a program for allowing the information processing device to have a function as the estimation information providing server 2602. The estimation information providing server 2602 is realized by providing the program on the main memory and executing the program by the CPU. Then, the estimation information providing server 2602 executes a method for paying the incentive in accordance with the estimation information. The program may not necessarily be stored in the storing device in the information processing device and the program may be provided from an external device, for example, an ASP (Application Service Provider) server and be provided on the main memory.

The product information providing server 2602 comprises communication control means 3301, product information providing means 2609, estimation information ID requesting means 2610, product information request receiving means 2611, and incentive giving instructing means 2612.

The communication control means 3301 receives information from the communication network 2600 and transmits information to the communication network 2600, and is a front end communication processor comprising a CPU for executing a protocol stack and a predetermined communication sequence in accordance with the protocol stack.

The product information providing means 2609 has a function for providing the product information in response to the request from the first user terminal device 2603. The product information is transmitted to the first user terminal device 2603 in, e.g., a Web document data format.

The estimation information ID requesting means 2610 has a function for transmitting the request for issuing the estimation information ID to the estimation information management device 2601 when receiving the request for issuing the estimation information ID from the first user terminal device 2603.

The product information request receiving means 2611 has a function for receiving the instruction from the estimation information management device 2601 and for transmitting the product information to the second user terminal device 2603 in response to the instruction.

The incentive giving instructing means 2612 has a function for, when receiving a notification indicating the purchase of the product from the second user terminal device 2603, sending a request for the incentive payment processing of the user of the first user terminal device 2603, to the estimation information management device 2601.

### [User Terminal Device]

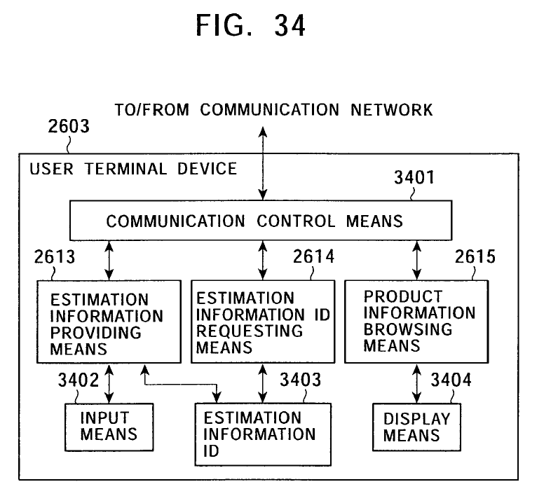

Next, a description is given of an example of the structure of the user terminal device 2603 with reference to FIG. 34.

FIG. 34 is a block diagram showing an example of the structure of the user terminal device 2603.

The user terminal device 2603 functions as a user terminal device used by the information provider 2201 described with reference to FIGS. 22 to 25 and as the user terminal device used by the buyer 2401.

The user terminal device 2603 sends a request of the product information to the product information providing server 2602, receives and browses the request, issues a request for issuing the estimation information ID to the product information providing server 2602, receives and stores the estimation information ID provided by the estimation information management device 2601 in response to the request, and provides the information on the estimation comment and the estimation information ID to the user terminal device 2603.

The user terminal device 2603 is an information processing device comprising a CPU, a main memory (RAM), a ROM, an input/output (I/O) device, an external storing device of a hard disk device, etc. and is, e.g., a computer, a work station, a mobile communication terminal, a PDA (Personal Digital Assistant), or a mobile phone. The ROM or the hard disk device stores a program for allowing the information processing device to have a function as the user terminal device 2603 according to the fourth embodiment or a program for implementing a method for payment of the incentive based on the estimation information. The user terminal device 2603 is realized by providing the program on the main memory or executing the program by the CPU. The program may not necessarily be stored in the storing device in the information processing device and the program may be provided from an external device, for example, an ASP (Application Service Provider) server and be provided on the main memory.

The user terminal device 2603 comprises communication control means 3401, estimation information providing means 2613, product estimation information ID requesting means 2614, product information browsing means 2615, input means 3402, estimation information ID storing means 3403, and display means 3404.

The communication control means 3401 has a function for receiving information from the communication network 2600 and transmitting information to the communication network 2600, and is a front end communication processor comprising a CPU for executing a protocol stack and a predetermined communication sequence in accordance with the protocol stack.

The product information browsing means 2615 requests the product information to the product information providing server 2602, receives the product information, and sends it to the display means 3404.

The estimation information ID requesting means 2614 issues a request for issuing data on the estimation information ID to the product information providing server 2602, receives the data on the estimation information ID provided by the estimation information management device 2601 in response to the request, and sends it to the estimation information ID storing means 3403. The data on the estimation information ID data may be provided as an object which is started by activation thereof by the user and which stores a script for transmitting the request for the product information and the estimation information ID. When the data on estimation information ID corresponds to a character or number data, the character or number is inputted by the user in the user terminal device 2603 on the buyer side and is transmitted to the estimation information management device 2601.

The estimation information providing means 2613 obtains the estimation information ID stored in the estimation information ID storing means 3403, and provides information on an estimation comment to the other user terminal device 2603 together with the estimation information ID. According to the method for providing the information on the estimation comment, a push-type providing method such as an e-mail or a pull-type providing method for presenting the estimation information ID and the information on the estimation comment on the proper site and for transmitting the information after access from the other user terminal device 2603 may be used.

The input means 3402 receives the input from the user of the key board or the pointing device and provides the information on the estimation comment or the table formed by the user to the estimation information providing means 2613.

The estimation information ID storing means 3403 receives the estimation information ID from the estimation information ID requesting means 2614 and stores the estimation information ID.

The display means 3404 receives data in a display data format and provides the data in a user recognizable format, and is, e.g., a liquid crystal display device, a CRT device, or the like.

### [Example of System Operation]

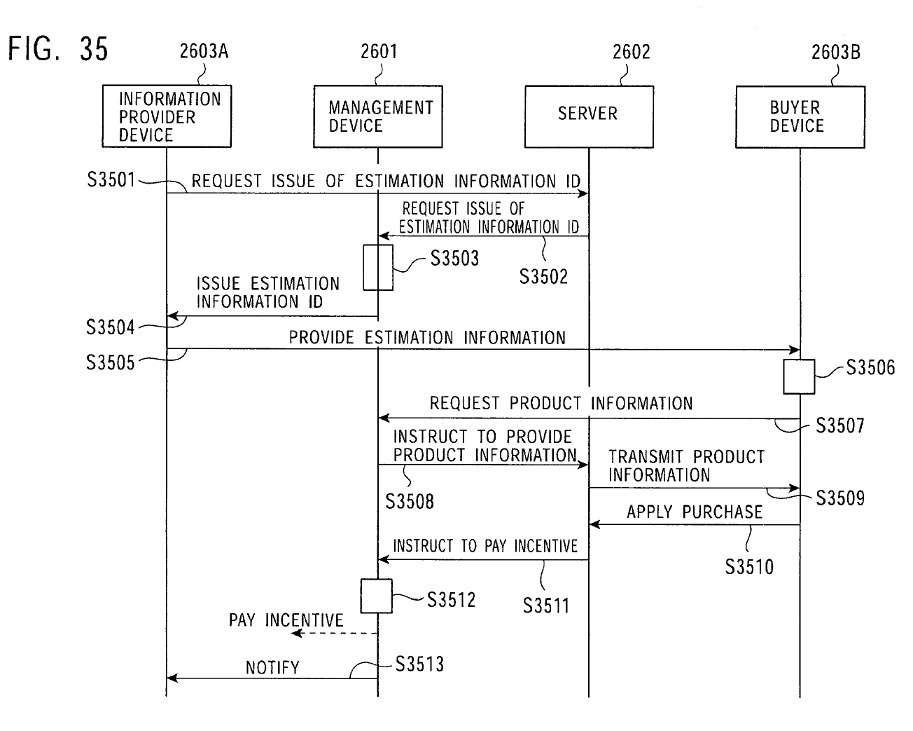

Next, an example of the system operation will be described with reference to FIGS. 35 to 39.

FIG. 35 is a sequence diagram showing the example of the operation from the request for issuing the estimation information ID from the user terminal device 2603 to the payment processing of the incentive to the user terminal device 2603 in the system. Referring to FIG. 35, the user terminal device 2603 used by the information provider 2201 corresponds to an information provider device 2603A, and the user terminal device 2603 used by the buyer 2401 corresponds to a buyer device 2603B.

It is assumed that the information provider 2201 has already bought a product X from the product information providing server 2602 by the information provider device 2603A.

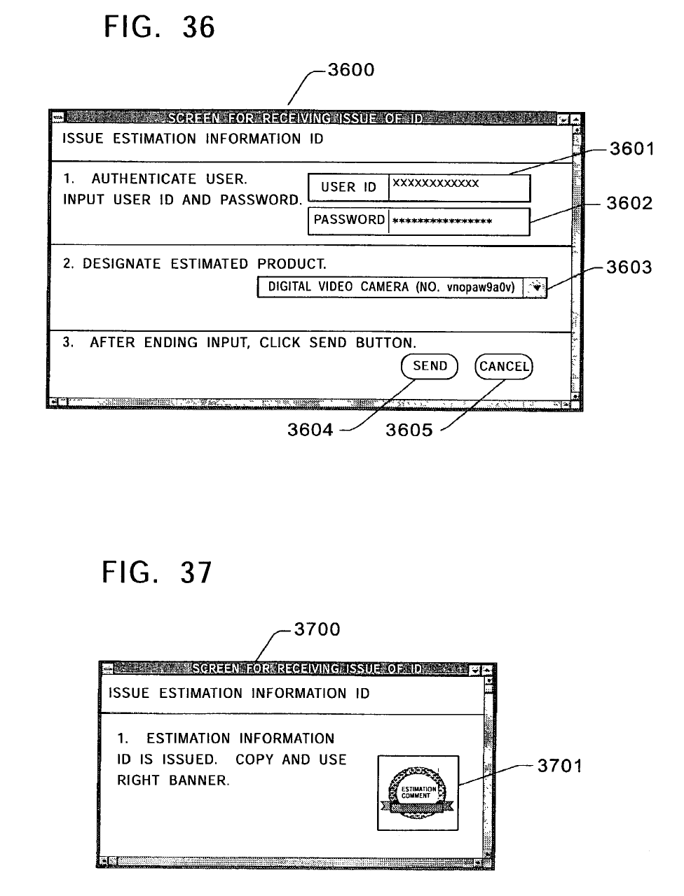

The information provider 2201 accesses the product information providing server 2602 by the information provider device 2603A. FIG. 36 shows an example of the structure of a screen for receiving the issue of the estimation information ID to be transmitted to the information provider device 2603A. In the example, a window 3600 may be provided by basic software (OS) installed in the information provider device 2603A, or may be provided by another software, e.g., the product information browsing means 2615. Windows in the following description are similar to the above-mentioned window 3600. The window 3600 has an area 3601 for inputting the user ID as information for specifying the user, and an area 3602 for inputting the password to confirm that the user is the registered one. Further, the window 3600 has a list box 3603 for specifying the product as an estimation target, a button 3604 for transmitting the input user ID and password and the product ID of the selected product to the product information providing server 2602, and a button 3605 for canceling the processing.

By pressing an enter key or clicking the pointing device to activate the button 3604, the information provider device 2603A transmits to the product information providing server 2602, the input user ID and password, the product ID of the selected product, and the request for issuing the estimation information ID (step S3501).

The product information providing server 2602 checks whether or not the user is registered based on the input user ID and password and checks whether or not the user purchases the product based on the product ID from a past log. Then, if it is determined that the user is reliable, the product information providing server 2602 transmits the user ID, the product ID, and the request for issuing the estimation information ID to the estimation information management device 2601 (step S3502).

The estimation information management device 2601 issues a new estimation information ID, and stores the user ID (hereinafter, referred to an estimator ID) and the product ID with a relationship thereamong, and generates the data on the estimation information ID (step S3503). The estimation information management device 2601 transmits the data on estimation information ID to the information provider device 2603A (step S3504). FIG. 37 shows an example of the screen for transmitting the data on the estimation information ID to the information provider device 2603A. In the example, the data on the estimation information ID is displayed as an object 3701 in a window 3700, and is stored in a local storing device of the information provider device 2603A by operations such as copy and paste.

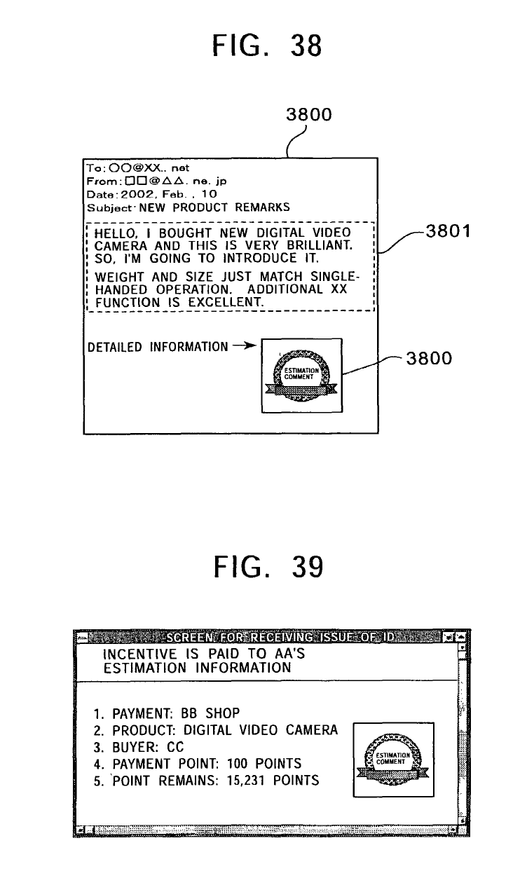

Next, the information provider 2201 transmits the estimation information to the buyer device 2603B from the information provider device 2603A. The estimation information comprises the data on the estimation information ID and the information on the estimation comment. FIG. 38 shows an example of a display screen of the estimation information when transmitting the estimation information by an e-mail. A display area 3800 in the display means 3404 of the buyer device 2603B displays estimation comment information 3801 by text and displays the data on the estimation information ID as an object 3802.

The buyer is interested in the estimation comment information 3801 by reading it and then might obtain the product information by activating the object 3802. The object 3802 is activated by a predetermined operation such as the click operation of the user (step S3506). Then, the buyer device 2603B requests the transmission of the product information corresponding to the estimation information ID to the estimation information management device 2601 (step S3507).

The estimation information management device 2601 which receives the request for transmitting the product information corresponding to the estimation information ID specifies the product information providing server 2602 for instructing the transmission of the product information by referring to the storing contents of the estimation information DB unit 2604 using the estimation information ID as a key, and transmits the instruction information indicating that the product information of the product X as the estimation target to be provided to the buyer device 2603B, addressed to the product information providing server 2602 (step S3508).

The product information providing server 2602 provides the product information of the product X to the buyer terminal device 2603B (step S3509). Various methods for providing the product information are considered. As an example, there is a method for describing and transmitting a URL (Uniform Resource Locator) on a Web page having the product information by an e-mail or a method for displaying the Web page having the product information by opening the window after transmitting the information by the push-type device.

When the user is interested in the product X, the buyer device 2603B transmits the purchase application to the product information providing server 2602 (step S3510).

The product information providing server 2602 which receives the product application transmits the estimation information ID and requests the processing for paying the incentive to the estimation information management device 2601 (step S3511).

The estimation information management device 2601 updates the storing contents of the incentive information DB unit 2608 in response to the request (step S3512). Specifically, a predetermined incentive point is added to an incentive point field of the record corresponding to the user of the information provider device 2603A on the estimator side.

Further, the estimation information management device 2601 may transmit the notification information indicating that the incentive point is added to the information provider device 2603A (step S3513). FIG. 39 shows an example of displaying the notification information on the information provider device 2603A.

### [Estimation of Estimator]

The estimation information management device 2601 receives the appraisal of the estimation information in response to the request from the user terminal device 2603. FIG. 40 shows an example of a screen for receiving the appraisal of the estimation information provided to the user terminal device 2603 from the estimation information management device 2601. The user of the user terminal device 2603 specifies the estimation information ID which is appraised in accordance with the screen and the product.

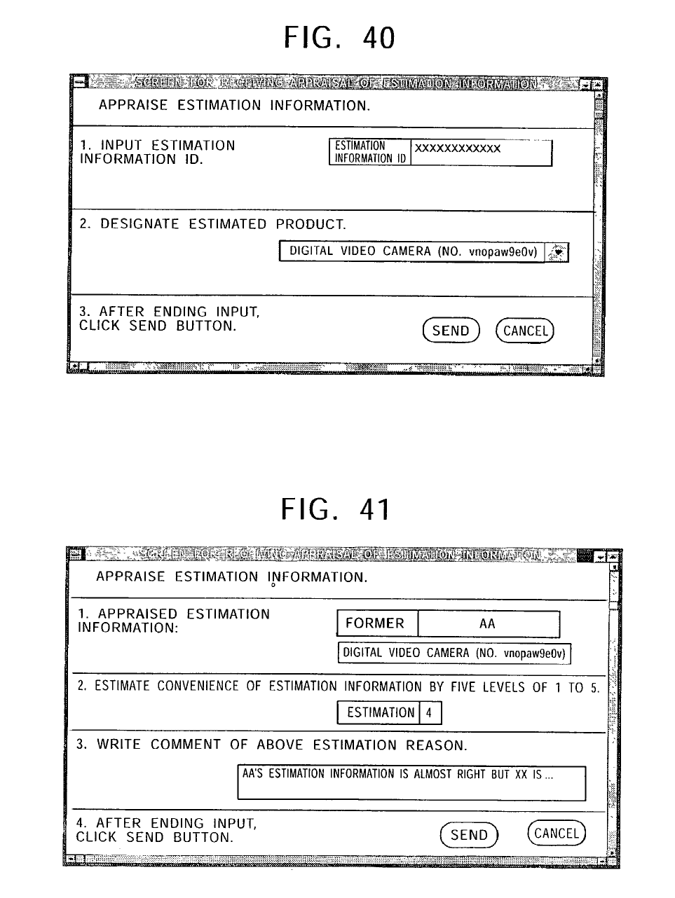

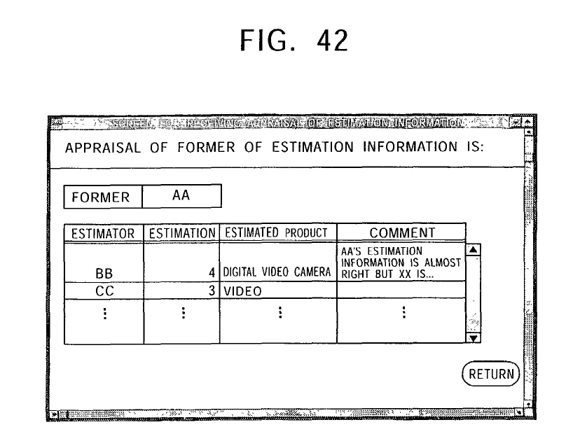

FIG. 41 shows an example of a screen for inputting the appraisal of the estimation information provided to the user terminal device 2603 from the estimation information management device 2601. In the example, values indicated by five-level estimations and the input of the comment indicating the appraisal reason are received.

The appraisal of the estimation information is stored in the estimation information management device and is browsed from the user terminal device 2603. FIG. 42 shows an example of a screen for displaying the appraisal of the estimation information browsed by the user terminal device 2603. In the example, the appraisal information on the former of the estimation information is displayed as a list.

By referring to the list information, it is determined whether or not the user as the buyer determines the product with which degree of reliability.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A content distributing system for distributing advertisement information concurrent with the distribution of content, the system comprising:
a communication network;
a content distributing server connected to said communication network; and
a member device connected to said communication network;
said content distributing server being operable to concurrently supply member-specified content and advertisement information to said member device in response to a request for the member-specified content from said member device, to transmit introducing information to the member device, to receive information on whether a user has performed an action in response to the introducing information, and to receive information provided by the user in accordance with the introducing information,
said member device being operable to transmit the request for the member-specified content to said content distributing server, to concurrently receive the member-specified content and advertisement information from said content distributing server, to concurrently display the member-specified content and the advertisement information, to receive the introducing information from the content distributing server, to receive the action by the user in response to the introducing information, and to transmit to the content distributing server the indication of whether the user has performed the action and the information provided by the user, and
said content distributing server being operable to record the received user action information and user-provided information, to calculate an advertisement charge based on the recorded information, and to output a calculated advertisement charge for an advertiser.

2. A system according to claim 1, wherein the introducing information includes a message indicating availability of detailed information on an advertised product and allows the user to issue a request for the detailed information.

3. A system according to claim 1, wherein the action performed by the user in response to the introducing information includes a charging action.

4. A system for distributing over a communication network advertisement information transmitted concurrent with the transmission of content to at least one of a plurality of member devices connected to the communication network and for processing a charge for the transmitted advertisement information, the system comprising:
a content distributing server connected to the communication network;
the content distributing server being operable to concurrently supply member-specified content and advertisement information to the at least one member device in response to a request for the member-specified content from the at least one member device, and including:
an introducing information transmitting unit operable to transmit introducing information to the member device,
a user action information receiving unit operable to receive information on whether a user has performed an action in response to the introducing information and to receive information provided by the user in accordance with the introducing information,
a user action recording unit operable to record the received user action information and user-provided information; and
a charge calculating unit operable to calculate the advertisement charge based on the information recorded by the user action recording unit and to output the calculated advertisement charge for the advertiser.

5. A system according to claim 4, further comprising:
an advertisement charge processing device connected to and for processing a charge for the transmitted advertisement information content distributing server;
wherein the content distributing server is operable to supply a transmission log to the advertisement charge processing device indicating that the advertisement information has been transmitted to the at least one member device, and
the advertisement charge processing device is operable to record the transmission log, to calculate an advertisement charge based on the transmission log, and to output a calculated advertisement charge, and includes:
an obtaining unit operable to obtain the transmission log from the content distributing server,
a transmitting and recording unit operable to record the transmission log, and
a charge calculating unit operable to calculate the advertisement charge based on the transmission log recorded by the transmitting and recording unit and to output the calculated advertisement charge,
a payment condition recording unit operable to record a unit price of an advertisement charge and a payment condition, and
an account calculating unit operable to calculate the advertisement charge by referring to the transmission log recorded by said transmitting and recording unit and the payment condition recorded by said payment condition recording unit.

6. A system according to claim 5, wherein the payment condition includes property information of a user as a transmission destination of the advertisement information.

7. A system according to claim 4, wherein the introducing information includes a message indicating availability of detailed information on an advertised product and allows the user to issue a request for the detailed information.

8. A system according to claim 4, wherein the action performed by the user in response to the introducing information includes a charging action.

9. A system for distributing advertisement information transmitted concurrent with the transmission of content to at least one of a plurality of member devices and for processing a charge for the transmitted advertisement information, the system comprising:
a processor encoded with instructions for carrying out a method, the method including:
transmitting a request for member-specified content from the at least one member device to a content distributing server;
concurrently supplying the member-specified content and advertisement information from the content distributing server to the at least one member device in response to the request;
concurrently displaying the specified content and the advertisement information at the at least one member device;
transmitting introducing information from the content distributing server to the at least one member device;
receiving, at the content distributing server from the at least one member device, information on whether a user has performed an action in response to the introducing information;
receiving, at the content distributing server from the at least one member device, information provided by the user in accordance with the introducing information;
recording the received user action information and user-provided information at the content distributing server;
calculating, at the content distributing server, an advertisement charge for the advertiser based on the recorded information; and
outputting the calculated advertisement charge from the content distributing server.

10. A system according to claim 9, wherein the method further includes:
supplying a transmission log from the content distributing server to an advertisement charge processing device, the transmission log indicating the advertisement information transmitted to the at least one member device;
recording the transmission log at the advertisement charge processing device;
calculating, at the advertisement charge processing device, an advertisement charge based on the recorded transmission log;
outputting the calculated advertisement charge from the advertisement charge processing device;
recording, at the advertisement charge processing device, a unit price of an advertisement charge and a payment condition; and
calculating, at the advertisement charge processing device, the advertisement charge by referring to the recorded transmission log and the payment condition.

11. A system according to claim 10, wherein the payment condition includes property information of a user as a transmission destination of the advertisement information.

12. A system according to claim 9, wherein the introducing information includes a message indicating availability of detailed information on an advertised product and allows the user to issue a request for the detailed information.

13. A system according to claim 9, wherein the action performed by the user in response to the introducing information includes a charging action.

14. A computer-readable medium having recorded therein instructions for carrying out a method of distributing advertisement information transmitted concurrent with the transmission of content to at least one of a plurality of member devices and for processing a charge for the transmitted advertisement information, the method comprising:
transmitting a request for member-specified content from the at least one member device to a content distributing server;
concurrently supplying the member-specified content and advertisement information from the content distributing server to the at least one member device in response to the request;
concurrently displaying the specified content and the advertisement information at the at least one member device;
transmitting introducing information from the content distributing server to the at least one member device;
receiving, at the content distributing server from the at least one member device, information on whether a user has performed an action in response to the introducing information;
receiving, at the content distributing server from the at least one member device, information provided by the user in accordance with the introducing information;
recording the received user action information and user-provided information at the content distributing server;
calculating, at the content distributing server, an advertisement charge for the advertiser based on the recorded information; and
outputting the calculated advertisement charge from the content distributing server.

15. A method of distributing advertisement information transmitted concurrent with the transmission of content to at least one of a plurality of member devices and for processing a charge for the transmitted advertisement information, the method comprising:
transmitting a request for member-specified content from the at least one member device to a content distributing server;
concurrently supplying the member-specified content and advertisement information from the content distributing server to the at least one member device in response to the request;
concurrently displaying the specified content and the advertisement information at the at least one member device;
transmitting introducing information from the content distributing server to the at least one member device;
receiving, at the content distributing server from the at least one member device, information on whether a user has performed an action in response to the introducing information;
receiving, at the content distributing server from the at least one member device, information provided by the user in accordance with the introducing information;
recording the received user action information and user-provided information at the content distributing server;
calculating, at the content distributing server, an advertisement charge for the advertiser based on the recorded information; and
outputting the calculated advertisement charge from the content distributing server.
